(19) United States
(12) Patent Application Publication
(10) Pub. No.: US 2024/0173696 A1
(43) Pub. Date: May 30, 2024

(54) FUNCTIONALISED HYDROGELS

(71) Applicant: COMMONWEALTH SCIENTIFIC AND INDUSTRIAL RESEARCH ORGANISATION, Australiian Capital Territory (AU)

(72) Inventors: Colin WOOD, Kensington (AU); Matthew MYERS, Kensington (AU); Cameron WHITE, Kensington (AU)

(21) Appl. No.: 18/549,132

(22) PCT Filed: Mar. 3, 2022
(86) PCT No.: PCT/AU2022/050169

§ 371 Date: Sep. 5, 2023

(30) Foreign Application Priority Data
Mar. 5, 2021 (AU) 2021900632

(51) Int. Cl. B01J 20/28; B01D 53/52; B01J 20/34; C08G 73/02

(52) U.S. Cl. CPC B01J 20/28047; B01D 53/526; B01J 20/34; C08G 73/0206; B01D 2257/304; B01D 2257/504

(57) ABSTRACT

The present disclosure is to functionalised polyamine hydrogels that can be used for capturing one or more acidic gases from gaseous streams and atmospheres. In particular, the present disclosure is directed to hydrogels comprising a cross-linked polyamine or copolymer thereof, wherein the cross-linked polyamine comprises one or more amine groups substituted with an optionally substituted alkanol group. Methods and apparatuses for removing acidic gases from gaseous streams or atmospheres using the functionalised hydrogels are also disclosed.

The present disclosure relates to functionalised hydrogels. In particular, the present disclosure relates to functionalised polyamine hydrogels that can be used for capturing one or more acidic gases from gaseous streams or atmospheres.

### BACKGROUND

Various approaches have been used for acidic gas (e.g. CO₂) capture including the use of liquid and solid-based sorbents. Liquid based sorbents that are employed typically comprise groups that chemically react with the acidic gas, including for example hydroxide or amine solutions which can capture CO₂ from low concentration streams. However, the rate of uptake and energy requirements to regenerate the hydroxide liquid based sorbents are challenging. In addition, many of the liquid based sorbents are also susceptible to oxidation, for example during regeneration, which present challenges in terms of long term stability, and are corrosive which limit industrial applicability.

To address this, various solid materials have been proposed including liquid sorbents supported on porous supports and porous materials such as porous silica and metal organic frameworks (MOFs). Whilst these materials offer lower regeneration energies compared to native solutions, the cost of synthesis can be high and inhibit large scale production. Additionally, many of these liquid porous support materials demonstrate decreased stability over time and reduced gas absorption performance due to degradation, and one of the biggest challenges with porous materials is the competitive adsorption of other components of the gas mixture (e.g. water) which can lower the overall acidic gas (e.g. CO₂) uptake substantially. Another factor to consider with porous materials is the volumetric requirements associated with packing a low density power, and leaching of the liquid sorbent out of the porous support especially at high temperatures.

Therefore, there is a need for alternative or improved materials for use in acidic gas capture which are scalable for industrial application and improved performance and/or stability across one or more absorption and desorption cycles (e.g. improved regeneration).

It will be understood that any prior art publications referred to herein do not constitute an admission that any of these documents form part of the common general knowledge in the art, in Australia or in any other country.

### SUMMARY

The present inventors have undertaken research and development into hydrogels and processes for removing acidic gases from gaseous streams or atmospheres using hydrogels. The hydrogels can be tailored to provide control over the acidic gas absorption and desorption (i.e. regeneration) efficiency. In particular, the hydrogels can remove acidic gases (e.g. CO₂ or H₂S) from gaseous streams or atmospheres by absorbing the acidic gas within the hydrogel thereby removing it from the gaseous stream. The absorbed acidic gas can then be harvested (e.g. desorbed) from the hydrogel, and the regenerated hydrogel can be reused to absorb more acidic gas from the gaseous stream (e.g. recycled).

In particular, the present inventors have identified that by functionalising the hydrogels with particular moieties, various properties of the hydrogel can be improved, including the hydrogels long term stability and/or regeneration which allows for good control over the acidic gas absorption efficiency, and in some embodiments easier regeneration and/or longer lifetimes. The present disclosure described herein can also be scalable for industrial application, and may find use particularly in the capture of acidic gases from natural gas streams, hydrocarbon sources, industrial effluent gas streams and/or the atmosphere. The present hydrogels can combine the advantages of liquids (high selectivity for acidic gases and low cost) with those of solids (low regeneration energy and high rate of uptake).

The hydrogel of the present disclosure comprises a cross-linked polyamine or a copolymer thereof. The cross-linked polyamine or copolymer thereof comprises one or more amine groups. The one or more amine groups may be primary (1º), secondary (2º) and/or tertiary (3º) amine groups. At least one or more of the amine groups of the cross-linked polyamine or copolymer thereof are substituted (e.g. functionalised) with an optionally substituted alkanol group.

In one aspect, there is provided a hydrogel comprising a cross-linked polyamine or copolymer thereof, wherein the cross-linked polyamine comprises one or more amine groups substituted with an optionally substituted alkanol group.

The hydrogel comprising a cross-linked polyamine of the present disclosure can also be a reaction product. The cross-linked polyamine or copolymer thereof can be a reaction product of a polyamine or copolymer thereof and a cross-linking agent. The cross-linked polyamine or copolymer thereof can be a reaction product of a polyamine or copolymer thereof, a functionalising agent (e.g. a functionalising epoxide) and a cross-linking agent.

In a second aspect, there is provided a hydrogel comprising a cross-linked polyamine or copolymer thereof, wherein the cross-linked polyamine or copolymer thereof is a reaction product of: a) a polyamine or copolymer thereof; b) a functionalising epoxide; and c) a cross-linking agent, wherein the cross-linked polyamine or copolymer thereof of the reaction product comprises one or more amine groups substituted with an optionally substituted alkanol group.

In one embodiment, the cross-linked polyamine or copolymer thereof is a reaction product of: a) an alkanol substituted polyamine or copolymer thereof, wherein the alkanol is optionally substituted; and b) a cross-linking agent.

In another embodiment, the cross-linked polyamine or copolymer thereof is a reaction product of: a) a cross-linked polyamine or copolymer thereof; and b) a functionalising epoxide.

In one embodiment, the alkanol substitution provides a cross-linked polyamine or copolymer thereof having an amine group distribution comprising a lower number of primary (1º) amine groups compared to the amine group distribution of a non alkanol substituted cross-linked polyamine or copolymer thereof.

In one embodiment, the alkanol substitution provides a cross-linked polyamine or copolymer thereof having an amine group distribution comprising less than about 30%, 25%, 20%, 15%, 10%, 5%, 4%, 3%, 2% or 1% of 1º amine groups, for example between about 5% to about 20% of 1º amine groups.

In one embodiment, the alkanol substitution provides a cross-linked polyamine or copolymer thereof having an amine group distribution comprising a secondary (2º):primary (1º) amine ratio of between about 1 to about 50.

In one embodiment, the optionally substituted alkanol group is an optionally substituted hydroxyethyl group.

In an embodiment, the hydrogel is provided as a plurality of particles. In one embodiment, the hydrogel is a self-supported hydrogel (e.g. the hydrogel is able to maintain its morphology and absorptive capacity in the absence of a support material). In an embodiment, the hydrogel comprises a liquid swelling agent. The liquid swelling agent may be water or non-aqueous solvent, for example a polar solvent. The polar solvent may also be capable of binding or dissolving an acidic gas, for example H₂S and/or CO₂.

In a third aspect, there is provided a process for preparing a hydrogel as defined above, comprising mixing a solution comprising a polyamine or copolymer thereof, cross-linking agent and a functionalising epoxide at a temperature and for a period of time effective to cross-link the polyamine or copolymer thereof, wherein one or more amine groups of the polyamine or copolymer thereof is functionalised by the epoxide to form the optionally substituted alkanol group.

In a fourth aspect, there is provided a method for removing an acidic gas from a gaseous stream or atmosphere, comprising contacting the gaseous stream or atmosphere with a hydrogel as defined above or a hydrogel prepared according to the process as defined above for absorbing at least some of the acidic gas from the gaseous stream or atmosphere.

In another aspect, there is provided an adsorption apparatus for capturing an acidic gas from a gaseous stream or atmosphere containing the acidic gas comprising: a chamber enclosing a hydrogel as defined above or a hydrogel prepared according to the process as defined above, the chamber comprising an inlet through which gaseous stream can flow to the hydrogel and an outlet through which the effluent gaseous stream can flow out from the hydrogel.

It will be appreciated that any one or more of the embodiments and examples described herein for the hydrogels may also apply to processes for preparing the hydrogels and methods for removing acidic gases from gaseous streams or atmospheres described herein. Any embodiment herein shall be taken to apply mutatis mutandis to any other embodiment unless specifically stated. It will also be appreciated that other aspects, embodiments and examples of the hydrogels, processes, methods, and systems, are described herein.

It will also be appreciated that some features of the hydrogels, processes, methods, and systems identified in some aspects, embodiments or examples as described herein may not be required in all aspects, embodiments or examples as described herein, and this specification is to be read in this context. It will also be appreciated that in the various aspects, embodiments or examples, the order of method or process steps may not be essential and may be varied.

### BRIEF DESCRIPTION OF FIGURES

Embodiments of the present disclosure are further described and illustrated as follows, by way of example only, with reference to the accompanying drawings in which:

FIG. 1: Illustration of the fabrication and structure of the functionalised hydrogels/

FIG. 2: Experimental set-up for evaluating the acidic gas absorption and desorption efficiency from functionalised hydrogels.

FIG. 3: Schematic of the experimental set-up for evaluating the DAC performance of the hydrogels. 1. Air compressor 2. Gas pressure gauge 3. Mass flow controller 4. Bubbler 5. Sample column 6. Isotopic analyzer.

FIG. 4: Experimental set-up for evaluating the DAC performance of the functionalised hydrogels at relatively large scale.

FIG. 5: Plot highlighting CO₂ absorption (w %) performance of functionalised polyamine hydrogels across 30 days. CO₂ absorption did not significantly change indicating good stability.

FIG. 6: Breakthrough curves for functionalized polyamine hydrogels comprising liquid swelling agent before ageing (orange curve) and after ageing (blue curve). The minimal change in uptake indicates good stability.

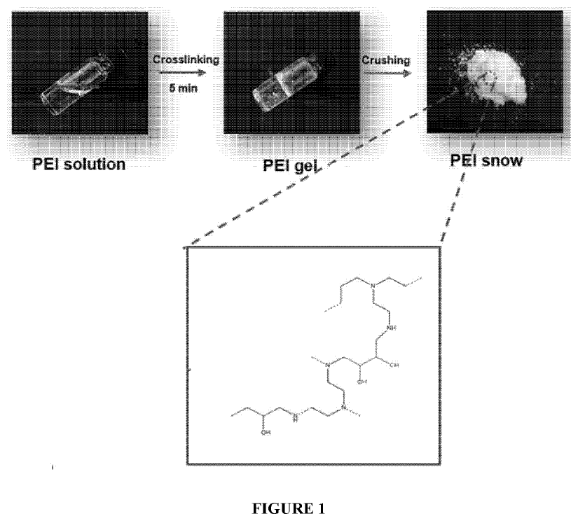

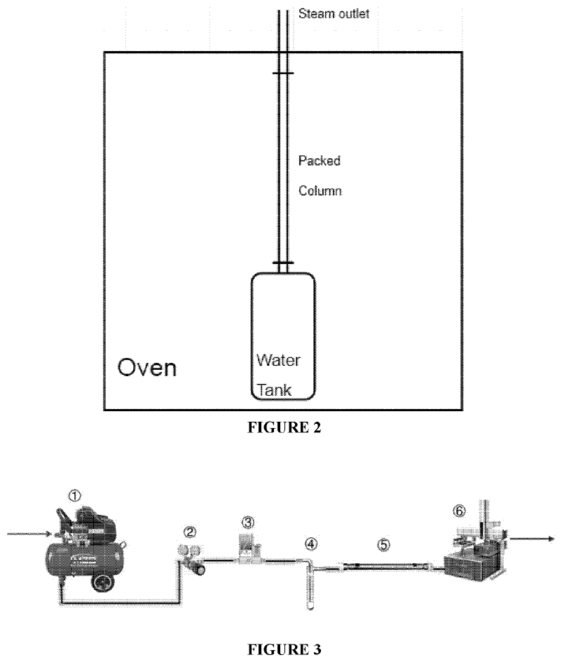

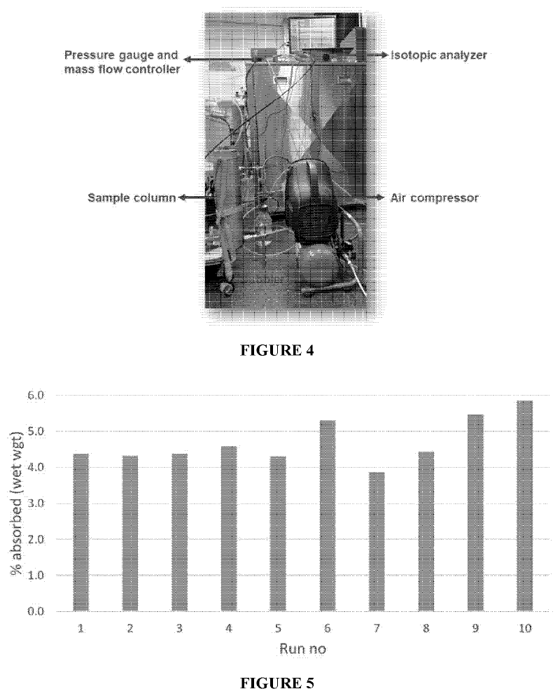

### DETAILED DESCRIPTION

The present disclosure describes the following various non-limiting embodiments, which relate to investigations undertaken to identify

### Terms

In the following description, reference is made to the accompanying drawings which form a part hereof, and which is shown, by way of illustration, several embodiments. It is understood that other embodiments may be utilized and structural changes may be made without departing from the scope of the present disclosure.

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the term “about”, unless stated to the contrary, typically refers to +/−10%, for example +/−5%, of the designated value.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The phrase “consisting of” means the enumerated elements and no others.

The reference to “substantially free” generally refers to the absence of that compound or component in the hydrogel, gaseous stream or atmosphere other than any trace amounts or impurities that may be present, for example this may be an amount by weight % in the total hydrogel, gaseous stream or atmosphere of less than about 1%, 0.1%, 0.01%, 0.001%, or 0.0001%. The hydrogels, gaseous streams or atmosphere as described herein may also include, for example, impurities in an amount by weight % in 30 the total composition, gaseous stream or atmosphere of less than about 5%, 4%, 3%, 2%, 1%, 0.5%, 0.1%, 0.01%, 0.001%, or 0.0001%. For example, this may be an amount by vol. % in the total gaseous stream or atmosphere of less than about 5%, 4%, 3%, 2%, 1%, 0.5%, 0.1%, 0.01%, 0.001%, or 0.0001%. For example, the gaseous streams or atmospheres as described herein may also include, for example, impurities in an amount 35 by vol. % in the total gaseous stream of less than about 5%, 4%, 3%, 2%, 1%, 0.5%, 0.1%, 0.01%, 0.001%, or 0.0001%. An example of such an impurity is the amount of methane (CH₄) that may be present in air, being present in an amount of less than 0.0005 vol. %.

The term “alkyl” or “alkylene” includes straight-chained and branched alkyl groups and includes both unsubstituted and substituted alkyl groups. In one example, the alkyl groups are straight-chained and/or branched, and optionally interrupted by 1-3 cyclic alkyl groups. Unless otherwise indicated, the alkyl groups typically contain from 1 to 30 carbon atoms. The alkyl groups may for example contain carbon atoms from 1 to 20, 1 to 15, 1 to 12, 1 to 10, or 1 to 8. Examples of “alkyl” as used herein include, but are not limited to, methyl, ethyl, n-propyl. n-butyl, n-pentyl, isobutyl, t-butyl, isopropyl, hexyl, n-octyl, n-heptyl, ethylhexyl, cyclopentyl, cyclohexyl, cyclo heptyl, adamantyl, and norbornyl, and the like. The alkyl groups may be optionally substituted and/or optionally interrupted by one or more heteroatoms. The alkyl groups may be referred to as “-alkyl-” in relation to use as a bivalent or polyvalent linking group. In some embodiments, the alkyl group may be selected from a C₁₋₂₀alkyl, C₁₋₁₀alkyl, C₁₋₆alkyl, such as methyl, ethyl, propyl, butyl, pentyl, and hexyl groups.

The term “alkanol” refers to an alkyl group as defined supra substituted by one or more hydroxyl groups. Examples of alkanol groups include, but are not limited to, alkanols having 1-10 carbon atoms, e.g., methanol, ethanol, C₃-alkanol, C₄-alkanol, C₅-alkanol, C₆-alkanol, C₇-alkanol, C₈-alkanol, C₉-alkanol, C₁₀-alkanol. The alkanol may be a structure according to Formula I, Ia, Ib or Ic described herein. The alkanol may be optionally substituted with one or more groups or moieties as defined supra.

The term “epoxide” refers to compound characterized by the presence of at least one cyclic ether group, namely one wherein an ether oxygen atom is attached to two adjacent carbon atoms thereby forming a cyclic structure. The epoxide may be optionally substituted with one or more groups or moieties as defined supra.

The term “alkenyl” refers to both straight and branched chain unsaturated hydrocarbon groups with at least one carbon-carbon double bond. Examples of alkenyl groups include, but are not limited to, ethenyl, propenyl, butenyl, pentenyl, and hexenyl groups. In some embodiments, the alkenyl group is of 2 to 20 carbon atoms (i.e. C₂₋₂₀alkenyl), 2 to 10 carbons (i.e. C₂₋₁₀alkenyl) or 2 to 6 carbons (i.e. C₁₋₆alkenyl).

The term “alkynyl” refers to both straight and branched chain unsaturated hydrocarbon groups with at least one carbon-carbon triple bond. Examples of alkynyl groups include, but are not limited to, ethynyl, propynyl, butynyl, pentynyl, and hexynyl groups. In some embodiments, the alkynyl group is of 2 to 20 carbon atoms (i.e. C₂₋₂₀alkynyl), 2 to 10 carbons (i.e. C₂₋₁₀alkynyl) or 2 to 6 carbons (i.e. C₁₋₆alkynyl).

The term “alkoxy” refers to an alkyl group as defined supra having an oxygen attached thereto, for example an —O-alkyl group. In some embodiments, the alkoxy group is of 1 to 20 carbons (i.e. C₁₋₂₀alkoxy), 1 to 10 carbons (i.e. C₁₋₁₀alkoxy), or 1 to 6 carbons (i.e. C₁₋₆alkoxy).

The term “cycloalkyl” represents a mono-, bicyclic, or tricyclic carbocyclic ring system of from about 3 to about 30 carbon atoms, e.g., cyclopropyl, cyclobutyl, cyclopentyl, cyclohexyl or cycloheptyl. The cycloalkyl groups may be referred to as “-cycloalkyl-” in relation to use as a bivalent or polyvalent linking group. In some embodiments, the cycloalkyl group is of 3 to 20 carbon atoms (i.e. C₃₋₂₀cycloalkyl), 3 to 10 carbons (i.e. C₃₋₁₀cycloalkyl) or 3 to 6 carbons (i.e. C₃₋₆cycloalkyl).

The terms “carbocyclic” and “carbocyclyl” represent a monocyclic or polycyclic ring system wherein the ring atoms are all carbon atoms, e.g., of about 3 to about 20 carbon atoms, and which may be aromatic, non-aromatic, saturated, or unsaturated, and may be substituted and/or contain fused rings. Examples of such groups include aryl groups such as benzene, saturated groups such as cyclopentyl, or fully or partially hydrogenated phenyl, naphthyl and fluorenyl. It will be appreciated that the polycyclic ring system includes bicyclic and tricyclic ring systems.

The term “aryl” whether used alone, or in compound words such as arylalkyl, represents: (i) an optionally substituted mono-, bicyclic or tricyclic aromatic carbocyclic moiety of about 6 to about 20 carbon atoms, such as phenyl, naphthyl, or triphenyl; or, (ii) an optionally substituted partially saturated bicyclic carbocyclic aromatic ring system in which an aryl and a cycloalkyl or cycloalkenyl group are fused together to form a cyclic structure such as a tetrahydronaphthyl, indenyl ,indanyl or fluorene ring. The aryl groups may be referred to as “-aryl-” in relation to use as a bivalent or polyvalent linking group. In some embodiments, the aryl group is of 3 to 20 carbon atoms (i.e. C₃₋₂₀aryl), 3 to 10 carbons (i.e. C₃₋₁₀aryl) or 3 to 6 carbons (i.e. C₃₋₆aryl). The term “arylalkyl” represents a —R—aryl group where the R group is an alkyl group, and the alkyl and aryl groups are each defined supra. The arylalkyl groups may be referred to as “-arylalkyl-” in relation to use as a bivalent or polyvalent linking group.

The term “heteroalkyl” represents an alkyl group as defined supra comprising one or more heteroatoms, for example wherein the alkyl group is interrupted with one or more (e.g. 1 to 5 or 1 to 3) heteroatoms. It will be appreciated that heteroatoms may include O, N, S, or Si. In one example the heteroatoms is O. The heteroalkyl groups may be referred to as “-heteroalkyl-” in relation to use as a bivalent or polyvalent linking group. In some embodiments, the heteroalkyl group is of 1 to 20 carbon atoms (i.e. C₁₋₂₀heteroalkyl), 1 to 10 carbons (i.e. C₁₋₁₀heteroalkyl) or 1 to 6 carbons (i.e. C₁₋₆heteroalkyl). The term “heteroarylalkyl” represents a —R—aryl group where the R group is an alkyl group, and the alkyl and aryl groups are each defined supra, which is interrupted by one or more heteroatoms and optionally substituted as described herein. The heteroarylalkyl groups may be referred to as “-heteroarylalkyl-” in relation to use as a bivalent or polyvalent linking group.

The term “heterocyclyl”, “heterocycl” or “heterocyclic” represents a monocyclic or polycyclic ring system wherein the ring atoms are provided by at least two different elements, typically a combination of carbon and one or more of nitrogen, sulphur and oxygen, although may include other elements for ring atoms such as selenium, boron, phosphorus, bismuth and silicon, and wherein the ring system is about 3 to about 20 atoms, and which may be aromatic such as a “heteroaryl” group, non-aromatic, saturated, or unsaturated, and may be substituted and/or contain fused rings. For example, the heterocyclyl may be (i) an optionally substituted cycloalkyl or cycloalkenyl group, e.g., of about 3 to about 20 ring members, which may contain one or more heteroatoms such as nitrogen, oxygen, or sulfur (examples include pyrrolidinyl, morpholino, thiomorpholino, or fully or partially hydrogenated thienyl, furyl, pyrrolyl, thiazolyl, oxazolyl, oxazinyl, thiazinyl, pyridyl and azepinyl); (ii) an optionally substituted partially saturated monocyclic or polycyclic ring system in which an aryl (or heteroaryl) ring and a heterocyclic group are fused together to form a cyclic structure (examples include chromanyl, dihydrobenzofuryl and indolinyl); or (iii) an optionally substituted fully or partially saturated polycyclic fused ring system that has one or more bridges (examples include quinuclidinyl and dihydro-1,4-epoxynaphthyl). It will be appreciated that the polycyclic ring system includes bicyclic and tricyclic ring systems. In some embodiments, the heterocyclyl group is of 3 to 20 carbon atoms (i.e. C₃₋₂₀ heterocyclyl), 3 to 10 carbons (i.e. C₃₋₁₀ heterocyclyl) or 3 to 6 carbons (i.e. C₃₋₆ heterocyclyl).

Examples of monocyclic non-aromatic heterocyclyl groups include aziridinyl, azetidinyl, pyrrolidinyl, imidazolidinyl, pyrazolidinyl, piperidinyl, piperazinyl, tetrahydrofuranyl, tetrahydropyranyl, morpholinyl, thiomorpholinyl and azepanyl. Examples of bicyclic heterocyclyl groups in which one of the rings is non-aromatic include dihydrobenzofuranyl, indanyl, indolinyl, isoindolinyl, tetrahydroisoquinolinyl, tetrahydroquinolyl, and benzoazepanyl. Examples of monocyclic aromatic heterocyclyl groups (also referred to as monocyclic heteroaryl groups) include furanyl, thienyl, pyrrolyl, oxazolyl, thiazolyl, imidazolyl, oxadiazolyl, thiadiazolyl, pyridyl, triazolyl, triazinyl, pyridazyl, isothiazolyl, isoxazolyl, pyrazinyl, pyrazolyl, and pyrimidinyl. Examples of bicyclic aromatic heterocyclyl groups (also referred to as bicyclic heteroaryl groups) include quinoxalinyl, quinazolinyl, pyridopyrazinyl, benzoxazolyl, benzothiophenyl, benzimidazolyl, naphthyridinyl, quinolinyl, benzofuranyl, indolyl, benzothiazolyl, oxazolyl[4,5-b]pyridyl, pyridopyrimidinyl, isoquinolinyl, and benzohydroxazole.

The term “hetaryl”, “heteroaryl” or “heteroaromatic” group, is an aromatic group or ring containing one or more heteroatoms, such as N, O, S, Se, Si or P. As used herein, “heteroaromatic” is used interchangeably with “hetaryl” or “heteroaryl”, and a heteroaryl group refers to monovalent aromatic groups, bivalent aromatic groups and higher multivalency aromatic groups containing one or more heteroatoms. For example, “heteroaryl” whether used alone, or in compound words such as alkylheteroaryl represents: (i) an optionally substituted mono- or polycyclic aromatic organic moiety, e.g., of about 5 to about 20 ring members in which one or more of the ring members is/are element(s) other than carbon, for example nitrogen, oxygen, sulfur or silicon; the heteroatom(s) interrupting a carbocyclic ring structure and having a sufficient number of delocalized π electrons to provide aromatic character, provided that the rings do not contain adjacent oxygen and/or sulfur atoms. Typical 6-membered heteroaryl groups are pyrazinyl, pyridazinyl, pyrazolyl, pyridyl and pyrimidinyl. All regioisomers are contemplated, e.g., 2-pyridyl, 3-pyridyl and 4-pyridyl. Typical 5-membered heteroaryl rings are furyl, imidazolyl, oxazolyl, isoxazolyl, isothiazolyl, oxadiazolyl, pyrrolyl, 1,3,4-thiadiazolyl, thiazolyl, thienyl, triazolyl, and silole. All regioisomers are contemplated, e.g., 2-thienyl and 3-thienyl. Bicyclic groups typically are benzo-fused ring systems derived from the heteroaryl groups named above, e.g., benzofuryl, benzimidazolyl, benzthiazolyl, indolyl, indolizinyl, isoquinolyl, quinazolinyl, quinolyl and benzothienyl; or, (ii) an optionally substituted partially saturated polycyclic heteroaryl ring system in which a heteroaryl and a cycloalkyl or cycloalkenyl group are fused together to form a cyclic structure such as a tetrahydroquinolyl or pyrindinyl ring. It will be appreciated that the polycyclic ring system includes bicyclic and tricyclic ring systems.

As used herein, the terms “halo” or “halogen”, whether employed alone or in compound words such as haloalkyl, means fluorine, chlorine, bromine or iodine.

As used herein, the term “haloalkyl” means an alkyl group having at least one halogen substituent, the terms “alkyl” and “halogen” being understood to have the meanings outlined above. Similarly, the term “monohaloalkyl” means an alkyl group having a single halogen substituent, the term “dihaloalkyl” means an alkyl group having two halogen substituents and the term “trihaloalkyl” means an alkyl group having three halogen substituents. Examples of monohaloalkyl groups include fluoromethyl, chloromethyl, bromomethyl, fluoromethyl, fluoropropyl and fluorobutyl groups; examples of dihaloalkyl groups include difluoromethyl and difluoroethyl groups; examples of trihaloalkyl groups include trifluoromethyl and trifluoroethyl groups.

As used herein, the term “hydroxyl” or “hydroxyl” represents a —OH moiety.

As used herein, the term “carboxyl” or “carboxy” represents a C═O moiety.

As used herein, the term “carboxylic acid” represents a —CO₂H moiety.

As used herein, the term “nitro” represents a —NO₂ moiety.

As used herein, the term “alkanolamine” represents a chemical compound that contains both hydroxyl (—OH) and amino (e.g. primary —NH₂, secondary —NHR and/or -tertiary —NR₂) functional groups on an alkane backbone.

As used herein, the term “polyamine” represents a compound having two or more amines (e.g. primary (1º) amine —NH₂, secondary (1º) amine —NHR, and/or tertiary (1º) amine —NR₂ amine) functional groups.

The term “polyalkylenimine” represents a compound comprising an alkylene backbone wherein one or more H atoms are substituted for an amino (e.g. primary (1º) amine —NH₂, secondary (1º) amine —NHR and/or -tertiary (1º) amine —NR₂) functional groups, and includes copolymers or derivatives thereof.

The term “acrylamide” represents a compound with the chemical formula CH₂═CHCNH₂ and includes derivatives thereof, for example methacrylamide.

The term “acrylic acid” represents a compound with the formula CH₂═CHCOOH and includes derivatives thereof, for example methacrylic acid.

The term “acrylate” represents a salt, ester or conjugate base of acrylic acid. The acrylate ion is the anion CH₂═CHCOO⁻. Examples include methyl acrylate, potassium acrylate and sodium acrylate, and methyl methacrylate.

The term “polyacrylate” represents a polymer comprising two or more acrylate monomers, and includes copolymers or derivatives thereof, for example poly(2-hydroxyethylmethacrylate).

The term “glycol” represents a class of compounds comprising two or more hydroxyl (—OH) groups, wherein the hydroxyl groups are attached to a different carbon atom.

The term “polyol” represents a compound containing two or more hydroxyl (—OH) groups.

The term “piperidine” represents a compound having the formula (CH₂)₅NH.

The term “optionally substituted” means that a functional group is either substituted or unsubstituted, at any available position. The term “substituted” or “functionalised” refers to a group having one or more hydrogens or other atoms removed from a carbon or suitable heteroatom and replaced with a further group (i.e., substituent). For example, the hydrogen of an amine group is removed from the nitrogen of the amine group, and replaced with a further group, including for example an optionally substituted alkanol. The term “unsubstituted” refers to a group that does not have any further groups attached thereto or substituted therefore.

The term “optionally interrupted” means a chain such as an alkyl chain may be interrupted by one or more (e.g. 1 to 3) functional groups such as amine, epoxide, carboxyl, carboxylic acid, and/or one or more heteroatoms such as N, S, Si, or O, at any position in the chain, for example to provide a heteroalkyl group. In one example, “optionally interrupted” means a chain such as an alkyl chain is interrupted by one or more (e.g. 1 to 3) heteroatoms such as N, S, or O.\

The term “functionalizing epoxide” refers to a compound comprising an epoxide moiety (e.g. 1,2-epoxybutane) which can react with an amine group via amine epoxide addition to form an amine group substituted with an optionally substituted alkanol group. The functionalizing epoxide may be a structure according to Formula II, IIa, or IIb described herein. The functionalizing epoxide may be optionally substituted with one or more groups or moieties as defined supra. It will be appreciated that the alkanol moiety is the reaction product of the amine-epoxide addition.

### Hydrogels

The term “hydrogel” refers to a three-dimensional (3D) network of cross-linked hydrophilic polymers that can swell and hold a large amount of water and other liquids while maintaining the structure due to chemical or physical cross-linking of individual hydrophilic polymer chains. The hydrogel comprises a cross-linked hydrophilic polymer, for example a cross-linked polyamine or copolymer thereof. The absorbed water/liquid is taken into the cross-linked hydrophilic polymeric matrix of the hydrogel through hydrogen bonding rather than being contained in pores from which the fluid could be eliminated by squeezing. Unlike other more complex inorganic scaffolds and supports, such as zeolites or metal organic frameworks (MOFs), after removing the solvent the hydrogel does not retain a measurable dry state porosity. So while hydrogels are capable of absorbing large amounts of liquid, the cross-linked hydrophilic polymer matrix itself is considered a three-dimensional “solid”, which is soft and elastic when swollen with a liquid (e.g. with water), but when the liquid is removed the hydrogel collapses and does not retain any porous network structure.

Hydrogels are capable of absorbing and retaining large amounts of a liquid swelling agent (such as water or a non-aqueous solvent) relative to its mass. In some embodiments, the hydrogel is capable of absorbing up to 300 times its own weight in fluid, for example at least double its own weight in fluid. The surface area within the hydrogel may be increased depending on the degree of swelling of the hydrogel. For example, the hydrogel may comprising a liquid swelling agent (such as water or an alkanolamine) which swells the hydrophilic polymer network of the hydrogels into a more open mobile structure with liquid-filled pores which may increase the accessibility of acidic gases (e.g. CO₂ or H₂S) to the reactive functional groups on the hydrophilic polymer and/or on the liquid swelling agent. Similar to the distribution of the cross-linker, it will be appreciated that, when present, the liquid swelling agent (e.g. water) is also distributed throughout the swollen hydrogel and retained within the cross-linked hydrophilic polymeric matrix through hydrogen bonding. This is unlike conventional porous supports (e.g. porous silica) where liquid sorbents are contained as discrete reservoirs in the pores of the support, or they have limited interaction with the surface which can readily leach out especially at high regeneration temperatures.

Hydrogels also have a swelling capacity (sometimes referred to as the maximum swelling capacity), which essentially defines the swelling limit of the polymer. The hydrogel may have a swelling capacity (i.e. is capable of absorbing) of between about 20 grams of liquid per gram of hydrogel (g/g) to about 200 (g/g) when measured using standard gravimetric analysis. The typical method to determine this is by taking a known weight of the dry hydrogel and swelling in an excess of liquid for a specified period of time (typically 48 hours). After which time the excess liquid is removed by filtration and the hydrogel weight is recorded to determine the swelling ratio. By way of example, to determine the swelling capacity of a hydrogel, a known mass (g) of a dry hydrogel is dispersed in a liquid swelling agent (such as water) for 48 hours at room temperature, after which any non-absorbed free liquid is removed, and the swollen hydrogel is weighed. The mass difference between the dry and swollen state of the hydrogel corresponds to the amount of the absorbed liquid, which is then calculated as a grams of liquid per gram of hydrogel (g/g).

In some embodiments, the hydrogel may have swelling capacity of at least about 1, 5, 10, 20, 30, 40, 50, 60, 70, 80, 90, 100, 150, or 200 g/g. In other embodiments, the hydrogel may have a swelling capacity of less than about 200, 150, 100, 90, 80, 70, 60, 50, 40, 30, 20, 10, 5 or 1 g/g. Combinations of these swelling capacity values to form various ranges are also possible, for example the hydrogel may have a swelling capacity of between about 1 g/g to about 100 g/g, for example between about 20 g/g to about 100 g/g.

The swelling capacity of the hydrogel can also vary depending on the liquid swelling agent. For example, the hydrogel may have a different swelling capacity with water as the liquid swelling agent compared to glycerol as the liquid swelling agent. For example, the hydrogel may have a swelling capacity of between about 1 g/g to about 200 g/g, for example between about 20 g/g to about 200 g/g water. In some embodiments, the hydrogel may have swelling capacity of at least about 1, 5, 10, 20, 30, 40, 50, 60, 70, 80, 90, 100, 150, or 200 g/g water. In other embodiments, the hydrogel may have a swelling capacity of less than about 200, 150, 100, 90, 80, 70, 60, 50, 40, 30, 20, 10, 5 or 1 g/g water. Combinations of these swelling capacity values to form various ranges are also possible, for example the hydrogel may have a swelling capacity of between about 1 g/g to about 100 g/g water, for example between about 20 g/g to about 100 g/g water.

In another example, the hydrogel may have a swelling capacity of between about 1 g/g to about 200 g/g, for example between about 20 g/g to about 200 g/g glycerol. In some embodiments, the hydrogel may have swelling capacity of at least about 1, 5, 10, 20, 30, 40, 50, 60, 70, 80, 90, 100, 150, or 200 g/g glycerol. In other embodiments, the hydrogel may have a swelling capacity of less than about 200, 150, 100, 90, 80, 70, 60, 50, 40, 30, 20, 10, 5 or 1 g/g glycerol. Combinations of these swelling capacity values to form various ranges are also possible, for example the hydrogel may have a swelling capacity of between about 1 g/g to about 100 g/g glycerol, for example between about 20 g/g to about 100 g/g glycerol.

In some embodiments, the hydrogel is swollen with a liquid swelling agent to between about 60% to about 99% of the hydrogels swelling capacity. For example, the hydrogel may be swollen to at least about 60, 70, 80, 90, 95, 98, or 99% of the hydrogels swelling capacity. The hydrogel may be swollen to less than about 99, 98, 95, 90, 80, 70, or 60% of the hydrogels swelling capacity. Combinations of these % values to form various ranges are also possible, for example the hydrogel may be swollen to between about 70% to about 98% of the hydrogels swelling capacity, for example between about 80% to about 95% of the hydrogels swelling capacity.

In some embodiments, the hydrogel is swollen with a liquid swelling agent at a ratio of at least about 1:1, 1:2, 1:5, 1:10, 1:15 or 1:20 by mass polyamine or copolymer thereof to liquid swelling agent.

The hydrogel may be capable of swelling and retaining about 0.5 wt. % to about 99 wt. % liquid swelling agent based on the total weight of the hydrogel. The liquid swelling agent may be strongly or weakly bound to the cross-linked polyamine or copolymer thereof network within the hydrogel or may be non-bound. The amount of liquid swelling agent in the hydrogel can vary depending on the degree of swelling or dehydration of the hydrogel. For example, the hydrogel may comprise between 0.5 wt. % to about 99 wt. % liquid swelling agent based on the total weight of the hydrogel. In some embodiments, the hydrogel may comprise at least about 0.5, 1, 5, 10, 20, 30, 40, 50, 60, 70, 80, 90, or 99 wt. % liquid swelling agent based on the total weight of the hydrogel. In some embodiments, the hydrogel may comprise less than about 99, 90, 80, 70, 60, 50, 40, 30, 20, 10, 5, 1, or 0.5 wt. % liquid swelling agent based on the total weight of the hydrogel. Combinations of these wt. % values to form various ranges are also possible, for example the hydrogel may comprise between about 30 wt. % to about 99 wt. % liquid swelling agent, for example between about 40 wt. % to about 99 wt. % liquid swelling agent based on the total weight of the hydrogel.

In some embodiments, the hydrogel comprises between about 50 wt. % to about 99 wt. % liquid swelling agent based on the total weight of the hydrogel. In some embodiments, the hydrogel comprises at least about 50, 55, 60, 65, 70, 75, 80, 85, 90, 95, or 99 wt. % liquid swelling agent based on the total weight of the hydrogel. In other embodiments, the hydrogel comprises less than about 99, 95, 90, 85, 80, 75, 70, 65, 60, 55, or 55 wt. % liquid swelling agent based on the total weight of the hydrogel t. Combinations of these wt. % values to form various ranges are also possible, for example the hydrogel comprises between about 85 wt. % to about 98 wt. % liquid swelling agent based on the total weight of the hydrogel. Suitable liquid swelling agents are described herein.

Alternatively, the hydrogel may be in a dry or dehydrated state where some of the absorbed liquid swelling agent is removed or evaporated. A dry hydrogel (also known as a dehydrated hydrogel) may comprise about 0.01% to about 20% liquid swelling agent based on the total weight of the hydrogel, for example between about 0.5 wt. % to about 10 wt. % liquid swelling agent based on the total weight of the hydrogel.

The hydrogel may have a surface area of between about 0.1 and 50 m²/g, about 25 m²/g, or 2 and 10 m²/g. The surface area (in m²/g) may be at least about 0.1, 0.5, 1, 2, 3, 4, 5, 6, 7, 8, 9, 10, 15, 20, 25, 30, 35, 40, or 45. The surface area (in m²/g) may be less than about 50, 45, 40, 35, 30, 25, 20, 15, 10, 9, 8, 7, 6, 5, 4, 3, 2, or 1. The surface area may be in a range provided by any two of these upper and/or lower values. The surface area may be provided for the hydrogel in a wet or dry state. It will be appreciated that the surface area will depend on particle size. The surface area can be measured using gas sorption with nitrogen or particle size analysis through microscopy.

The liquid swelling agent may be water, a non-aqueous solvent, or a combination thereof. The non-aqueous solvent may be a polar solvent. The liquid swelling agent may comprise one or more functional groups capable of binding to an acidic gas (e.g. CO₂ or H₂S), for example an amine. Alternatively, the liquid swelling agent comprises a group that can help to dissolve the acidic gases (e.g. CO₂ or H₂S) and/or can assist the polymer matrix in stabilizing/solvating the bound acidic gas, for example hydroxyl groups.

The liquid swelling agent has a boiling point. The boiling point may be at least about 100° C. For example, the liquid swelling agent may have a boiling point of at least about 100, 120, 140, 160, 200, 220, 240, 260, 280, or 300° C. The liquid swelling agent may have a boiling point of less than about 300, 280, 260, 240, 220, 200, 160, 140, 120, or 100° C. Combinations of these boiling points to provide various ranges are also possible, for example the liquid swelling agent has a boiling point of between about 100° C. to about 300° C. The boiling point of the liquid swelling agent can vary depending on the liquid swelling agent, for example water has a boiling point of about 100° C., glycerol has a boiling point of about 290° C., and monoethylene glycol (MEG) has a boiling point of about 198° C. According to at least some embodiments or examples described herein, high boiling point solvents may result in lower evaporation loss of the solvent when the hydrogel comprising the solved as a liquid swelling agent is subjected to regeneration (e.g. heating with steam) to remove captured acidic gases (e.g. CO₂ or H₂S), resulting in the acidic gas being selectively removed before the solvent evaporates.

The liquid swelling agent may be capable of absorbing acidic gases (e.g. CO₂ or H₂S) by a chemical process, for example by binding to the acidic gas via one or more functional groups present in the liquid swelling agent. Suitable liquids that are capable of absorbing the acidic gas by a chemical process include, but are not limited to, alkanolamines, alkylamines, alkyloxyamines, piperidine and its derivatives, piperazine and its derivatives, pyridine and its derivatives, and mixtures thereof, as described herein.

The liquid swelling agent may be selected from the group consisting of water, alcohols, polyol compounds, glycols, amines (e.g. alkanolamines, alkylamines, alkyloxyamines), piperidines, piperazines, pyridines, pyrrolidones, and derivatives or combinations thereof. Suitable alkanolamines may include monoethanolamine, diethanolamine, methyldiethanolamine, diisopropanolamine, N-ethylmonoethanolamine and aminoethoxyethanol. Suitable alkylamines may include an ethyleneamine, for example tetraethylpentamine (TEPA). Suitable glycols may include ethylene glycol, monoethylene glycol, diethylene glycol, triethylene glycol, propylene glycol, propanediol, butylene glycol, Triethylene glycol, polyethylene glycol (e.g. PEG 200), and diglyme. Suitable alcohols may include 2-ethyoxyethanol, 2-methoxyethanol. Suitable polyol compounds may include glycerol. Suitable piperidines include piperidine, 2-methylpiperidine, 3-methylpiperidine, 4-methylpiperidine, 2-piperidineethanol (PE), 3-piperidinemthanol, and 4-piperidinemthanol. The liquid swelling agent may comprise any one or more of the above liquids.

In some embodiments, the liquid swelling agent may be selected from the group consisting of water, monoethanolamine, diethanolamine, methyldiethanolamine, diisopropanolamine, N-ethylmonoethanolamine, aminoethoxyethanol, ethylene glycol, triethylene glycol, monoethylene glycol, diethylene glycol, triethylene glycol, propylene glycol, propanediol, butylene glycol, polyethylene glycol, glycerol, diglyme, 2-ethyoxyethanol, 2-methoxyethanol, glycerol, 2-methylpiperidine, 3-methylpiperidine, 4-methylpiperidine, 2-piperidineethanol (PE), 3-piperidinemthanol, and 4-piperidinemthanol.

Suitable liquids capable of absorbing acidic gases (e.g. CO₂ or H₂S) by a physical process (e.g. do not chemically bind to the acidic gas but can dissolve it) include but are not limited to polyethylene glycol-dimethyl ethers (Selexol), N-methylpyrrolidone, propylene carbonate, methanol, sulfolane, imidazoles, ionic liquids, primary amines, secondary amines, tertiary amines, sterically hindered amines, and mixtures thereof.

In one embodiment, the liquid swelling agent is water, glycerol, monoethanolamine, diethanolamine, 2-piperidineethanol, ethylene glycol, triethylene glycol, polyethylene glycol (PEG) or monoethyleneglycol (MEG) or combinations thereof.

In some embodiments, the liquid swelling agent is capable of absorbing acidic gases (e.g. CO₂ or H₂S) when contacted with a gaseous stream or atmosphere. Suitable liquid swelling agents that are capable of absorbing acidic gases (e.g. CO₂ or H₂S) include one or more of the liquid swelling agents described herein. In some embodiments, the liquid swelling agent may absorb acidic gases (e.g. CO₂ or H₂S) by a chemical or physical process. In some embodiments, the liquid swelling agent comprises functional groups capable of binding to acidic gases (e.g. CO₂ or H₂S). For example, the liquid swelling agent may comprise one or more amine groups, such as a primary amine (—NH₂) or secondary amine group (—NH—). Such amine groups are H₂S and CO₂-phillic and readily react and bind with H₂S and CO₂. In some embodiments, the liquid swelling agent comprises one or more amine groups amine, such as an alkanolamine. In another example, the liquid swelling agent comprises two or more (—OH) groups which are capable of physically dissolving acidic gases (e.g. CO₂ or H₂S), for example a glycol, a polyol or dimethyl ethers as described herein.

In some embodiments, the hydrogel may comprise at least about 0.5, 1, 5, 10, 20, 30, 40, 50, 60, 70, 80, 90, or 99 wt. % water. In some embodiments, the hydrogel may comprise less than about 99, 90, 80, 70, 60, 50, 40, 30, 20, 10, 5, 1, or 0.5 wt. % water. Combinations of these wt. % values to form various ranges are also possible, for example the hydrogel may comprise between about 40 wt. % to about 99 wt. % water. The water may have a degree of salinity, e.g. may be a brine or salt water.

In some embodiments, the hydrogel may comprise at least about 0.5, 1, 5, 10, 20, 30, 40, 50, 60, 70, 80, 90, or 99 wt. % glycerol. In some embodiments, the hydrogel may comprise less than about 99, 90, 80, 70, 60, 50, 40, 30, 20, 10, 5, 1, or 0.5 wt. % glycerol. Combinations of these wt. % values to form various ranges are also possible, for example the hydrogel may comprise between about 40 wt. % to about 99 wt. % glycerol.

In some embodiments, the hydrogel may comprise at least about 0.5, 1, 5, 10, 20, 30, 40, 50, 60, 70, 80, 90, or 99 wt. % monoethyleneglycol (MEG). In some embodiments, the hydrogel may comprise less than about 99, 90, 80, 70, 60, 50, 40, 30, 20, 10, 5, 1, or 0.5 wt. % monoethyleneglycol (MEG). Combinations of these wt. % values to form various ranges are also possible, for example the hydrogel may comprise between about 40 wt. % to about 99 wt. % monoethyleneglycol (MEG).

In some embodiments, the hydrogel may comprise at least about 0.5, 1, 5, 10, 20, 30, 40, 50, 60, 70, 80, 90, or 99 wt. % of an alkanolamine. In some embodiments, the hydrogel may comprise less than about 99, 90, 80, 70, 60, 50, 40, 30, 20, 10, 5, 1, or 0.5 wt. % of an alkanolamine. Combinations of these wt. % values to form various ranges are also possible, for example the hydrogel may comprise between about 40 wt. % to about 99 wt. % of an alkanolamine. Suitable alkanolamines are described herein, for example diethanolamine (DEA).

In some embodiments, the hydrogel may comprise at least about 0.5, 1, 5, 10, 20, 30, 40, 50, 60, 70, 80, 90, or 99 wt. % of a glycol. In some embodiments, the hydrogel may comprise less than about 99, 90, 80, 70, 60, 50, 40, 30, 20, 10, 5, 1, or 0.5 wt. % of a glycol. Combinations of these wt. % values to form various ranges are also possible, for example the hydrogel may comprise between about 40 wt. % to about 99 wt. % of a glycol. Suitable glycols are described herein. In some embodiments, the hydrogel may comprise at least about 0.5, 1, 5, 10, 20, 30, 40, 50, 60, 70, 80, 90, or 99 wt. % polyethylene glycol (PEG). In some embodiments, the hydrogel may comprise less than about 99, 90, 80, 70, 60, 50, 40, 30, 20, 10, 5, 1, or 0.5 wt. % polyethylene glycol (PEG). Combinations of these wt. % values to form various ranges are also possible, for example the hydrogel may comprise between about 40 wt. % to about 99 wt. % polyethylene glycol (PEG).

In some embodiments, the hydrogel may comprise at least about 0.5, 1, 5, 10, 20, 30, 40, 50, 60, 70, 80, 90, or 99 wt. % a piperidine. In some embodiments, the hydrogel may comprise less than about 99, 90, 80, 70, 60, 50, 40, 30, 20, 10, 5, 1, or 0.5 wt. % a piperidine. Combinations of these wt. % values to form various ranges are also possible, for example the hydrogel may comprise between about 40 wt. % to about 99 wt. % a piperidine. Suitable piperidines are described herein.

The liquid swelling agent may further comprise an amino acid or salt thereof. The amino acid or salt thereof may be an aqueous or non-aqueous amino acid or salt thereof. The incorporation of an amino acid or salt thereof within the liquid swelling agent can improve acidic gas absorption. Due to the presence of the amino functional group, CO₂ can bind with the amino acid salt thus increasing CO₂ absorption. The amino acid or salt thereof may comprise any suitable amino acid, salt or derivative thereof, for example glycine, proline, sarcosine or a salt thereof. The amino acid salt may comprise any suitable salt, including ammonium salts, alkali metal salts for example those of potassium and sodium, alkaline earth metal salts for example those of calcium and magnesium, organic cation salts for example quaternary organic ammonium salts (e.g. tetramethylammonium, tetraethylammonium, tetrapropylammonium, tetrabutylammonium), pyrrolidinium or piperidinium. The amino acid salt may be potassium glycinate, potassium sarcosinate, potassium proline, or isopropyl glycinate. In one embodiment, the amino acid salt is potassium sarcosinate.

The liquid swelling agent may comprise at least 1, 2, 5, 10, 15, 20, 25, 30 or 40% w/v amino acid salt. The liquid swelling agent may comprise less than 40, 30, 25, 20, 15, 10, 5, 2 or 1% w/v amino acid salt. Combinations of these values are also possible, for example between about 5% to about 30% w/v amino acid salt.

The hydrogel may further comprise a chelator (i.e. a chelating agent). The chelator can improve the stability of the hydrogel by chelating to any residual metal that may be present as an impurity in the polyamine or copolymer thereof. The chelator may be a phosphate salt, for example potassium phosphate or sodium phosphate. In one embodiment, the chelator is sodium phosphate. Other suitable chelators can include EDTA, deferoxamine mesylate salt, chromium picolinate, zinc picolinate and pentetic acid. The chelator may also comprise one or more organic cation salts for example quaternary organic ammonium salts (such as tetramethylammonium, tetraethylammonium, tetrapropylammonium, tetrabutylammonium), pyrrolidinium or piperidinium, which in some embodiments may improve solubility and dispersion in the polymer matrix to improve its chelation performance.

The absorptive capacity of the hydrogel may be enhanced by incorporating a hygroscopic salt into the hydrogel, either as part of the cross-linked polyamine or copolymer thereof and/or as part of the liquid swelling agent, or as a separate aqueous solution that is absorbed into the hydrogel. The hygroscopic salt may be a monovalent salt such as lithium chloride, lithium bromide or sodium chloride, or a divalent salt such as calcium chloride, calcium sulphate. The hygroscopic salt may be present in the cross-linked polymer network in any amount up to saturation thereof.

Where a hydrogel comprises a non-aqueous solvent liquid swelling agent, the hydrogel may be prepared using the non-aqueous solvent as the dispersion medium (e.g. the polyamine or copolymer thereof is dispersed in the non-aqueous liquid swelling agent, and cross-linked therein to form the hydrogel). Alternatively, the hydrogel may be prepared using water or an alcohol as the dispersion medium, and is subsequently dried/dehydrated to remove the absorbed water, and then the non-aqueous solvent is added to the hydrogel and absorbed therein. For example, the dried hydrogel may be immersed in the non-aqueous solvent, and left for a period of time to infuse/absorb the non-aqueous solvent.

The hydrogel may be characterised by an elastic modulus. For example, the hydrogel may have an elastic modulus of between about 0.1 Pa to about 12,000 Pa. In some embodiments, the elastic modulus of the hydrogel may be at least about 0.1, 10, 30, 50, 100, 200, 500, 1,000, 2,000, 5,000, 8,000, 10,000 or 12,000 Pa. In some embodiments, the elastic modulus of the hydrogel may be less than about 12,000, 10,000, 8,000, 5,000, 2,000, 1,000, 500, 200, 100, 50, 30, 10, or 0.1 Pa. Combinations of these elastic modulus values to form various ranges are also possible, for example the elastic modulus of the hydrogel may be between about 100 Pa to about 5,000 Pa. The hydrogel may have an elastic modulus of between about 2,000 to about 5,000. In other embodiments, the elastic modulus of the hydrogel may be at least about 0.1, 10, 30, 50 or 100 Pa. In various embodiments, the elastic modulus of the hydrogel may be less than about 12,000, 10,000, 8000, or 6000 Pa. In some embodiments, the elastic modulus of the hydrogel may be between about 0.2 Pa to about 12000 Pa, about 0.2 Pa to about 10000 Pa, about 0.2 Pa to about 5000 Pa, about 1 Pa to about 12000 Pa, or about 1 Pa to about 10,000 Pa. In some embodiments, the elastic modulus of the hydrogel may be between about 10 Pa to about 12000 Pa, about 10 Pa to about 10,000 Pa, or about 100 Pa to about 10,000 Pa. In other embodiments, the elastic modulus of the hydrogel may be from between about 0.1 Pa to about 10,000 Pa, about 0.1 Pa to about 5000 Pa, about 0.1 Pa to about 1000 Pa, about 1 Pa to about 12,000 Pa, about 1 Pa to about 10,000 Pa, about 100 Pa to about 12,000 Pa, about 500 Pa to about 12000 Pa, or about 1000 Pa to about 12,000 Pa. In other embodiments, the elastic modulus of hydrogel may be between about 1 Pa to about 5000 Pa, about 10 Pa to about 5000 Pa, or about 100 Pa to about 5000 Pa. In some embodiments, the elastic modulus of the hydrogel is less than about 9,000, 5,000, or 4000 Pa.

The elastic modulus may be determined by a number of suitable techniques, including using a rheometer, for example a HR-3 Discovery Hybrid Rheometer (TA Instruments). A Rheometer can be used to control shear stress or shear strain and/or apply extensional stress or extensional strain and thereby determine mechanical properties of a hydrogel including the modulus of elasticity thereof.

The hydrogel may be provided in a wide range of morphologies. Illustrative examples of suitable morphologies may include particles, beads, sheets/layers, cast blocks, cylinders, discs, porous membranes and monoliths. For example, the hydrogel may be provided as a film/coating layer, for example a gel layer where the gaseous stream is flowed thereon or through the layer. Such layers may be a provided as a rolled sheet. Alternatively, the hydrogel layer may also be provided as a monolith comprising a plurality of porous channels, wherein the gaseous stream flows through. Other layer or coating morphologies and geometries are also applicable.

In one embodiment, the hydrogel may comprise a plurality of particles. The term “particle” (also referred to as “particulate”) refers to the form of discrete solid units. The units may take the form of flakes, fibres, agglomerates, granules, powders, spheres, pulverized materials or the like, as well as combinations thereof. The particles may have any desired shape including, but not limited to, cubic, rod like, polyhedral, spherical or semi-spherical, rounded or semi-rounded, angular, irregular, and so forth. The particle morphology can be determined by any suitable means such as optical microscopy. In one embodiment, the hydrogel may comprise a plurality of spherical or substantially spherical beads.

The hydrogel particles may be of any suitable size and/or shape and/or morphology. In one embodiment, the hydrogel particles may have an average particle size. For spherical hydrogel particles, the particle size is the diameter of the particles. For non-spherical hydrogel particles, the particle size is the longest cross-section dimension of the particles. In some embodiments, the hydrogel particles may have an average particle size in a range from about 10 μm to about 2000 μm, for example from about 10 p.m to about 1000 μm. The hydrogel particles may have an average particle size of at least about 10, 20, 50, 100, 200, 300, 400, 500, 700, 1000, 1500, or 2000 μm. In other embodiments, the hydrogel particles may have an average particle size of less than about 2000, 1500, 1000, 700, 500, 400, 300, 200, 100, 50, 20, or 10 μm. Combinations of these particle size values to form various ranges are also possible, for example the hydrogel particles may have an average particle size of between about 10 μm to about 500 μm, about 100 μm to about 400 μm, for example about 200 μm to about 300 μm. The average particle size can be determined by any means known to the skilled person, such as electron microscopy, dynamic light scattering, optical microscopy or size exclusion methods (such as graduated sieves). The hydrogel particles may have a controlled average particle size and can maintain their morphology in a range of different environments and shear conditions, for example while in contact with a gaseous stream and/or moist or dry environments.

In one embodiment, the hydrogel may be self-supporting. The term ‘self-supporting’ as used herein refers to the ability of the hydrogel to maintain its morphology in the absence of a support material (e.g. porous silica scaffold). For example, the hydrogel may comprise a plurality of particles, wherein the particles maintain their morphology in the absence of a scaffold support. The self-supported nature of the hydrogel may provide certain advantages, for example allows particles of hydrogel to be contacted with the gaseous stream using a fluidized bed reactor. Accordingly, in one embodiment, the hydrogel does not comprise a separate support structure, such as a separate porous support structure. This does not preclude from the hydrogel itself being porous in nature. Thus it will be understood that, where the hydrogel is “self-supporting”, there is no requirement for a support material (e.g. scaffold) exogenous to the hydrogel in order to function as an acidic gas absorbent.

In some embodiments, the hydrogel may be provided as layer within a column, wherein the gaseous stream or atmosphere is flowed through the column and passes through the hydrogel layer. The layer is not limited to any particular hydrogel morphology. In one example, a suitable column may be packed with a plurality of hydrogel particles to form a packed-bed with sufficient interstitial space between adjacent particles to allow a flow of gas therethrough. Alternatively, the hydrogel may be provided in flow with the gaseous stream (e.g. a fluidised bed reactor).

In some embodiments or examples, the hydrogel may be provided as a coating composition on a substrate. In some embodiments or examples, the substrate may be planar, for example a planar sheet. In a particular example, the substrate may be a flexible sheet. A planar substrate provides a two sided element onto which the hydrogel coating composition can be applied. Each substrate may be coated with the hydrogel coating composition on two opposing sides. The planar substrate can have any configuration. In some embodiments or examples, the planar substrate may comprise a flat solid surface. In other embodiments or examples, the planar substrate may comprise one or more apertures, designed to assist gas flow through and around the substrate. In a particular embodiment or example, the substrate may comprise a mesh, for example, micro wire mesh. The use of a mesh provides a multitude of apertures, (e.g. micro size apertures), thereby providing a high surface area on which the hydrogel coating composition can be applied, whilst also providing a suitable flow path having a reasonably low pressure drop across the substrate (relative to the size and configuration of the mesh) compared to other configurations, for example, packed beds. The hydrogel may be subsequently ground/pulverised into a plurality of particles.

### Polyamine or Copolymer Thereof

The polyamine or copolymer thereof can provide suitable mechanical and chemical properties to the hydrogel. For example, in some embodiments, the hydrogel may need to be able to withstand various shear and stress environments, such as when in contact with the gaseous stream and/or dry or moist/humid environments. In some embodiments, the hydrogel may also need to withstand a wide temperature range, for example when undergoing thermal regeneration. In some embodiments, the hydrogel may also need to be physically robust so that it can be introduced into various gas flowlines as a flow of particulate material or so that the particulate material can be provided in a packed bed with sufficient interstitial space between adjacent particles to allow a flow of gas (e.g. ambient air) therethrough. In some embodiments, the cross-linked polyamine or copolymer thereof is also chemically inert. Accordingly, one or more of these properties may be provided by the appropriate selection of the polyamine or copolymer thereof.

In some embodiments, the hydrogel comprises between about 0.05 wt. % to about 50 wt. % polyamine or copolymer thereof based on the total weight of the hydrogel. In some embodiments, the hydrogel comprises at least about 0.01, 0.05, 0.1, 0.2, 0.5, 1, 2, 5, 10, 15, 20, 25, 30, 35, 40, 45, or 50 wt. % polyamine or copolymer thereof based on the total weight of the hydrogel. In other embodiments, the hydrogel comprises less than about 50, 45, 40, 35, 30, 25, 20, 15, 10, 5, 2, 1, 0.5, 0.2, 0.1, 0.05 or 0.01 wt. % polyamine or copolymer thereof based on the total weight of the hydrogel. Combinations of these polyamine or copolymer thereof concentrations to form various ranges are also possible, for example the hydrogel comprises between about 0.01 wt. % to about 50 wt. %, about 0.05 wt. % to about 50 wt. %, about 1 wt. % to about 50 wt. %, about 0.05 wt. % to about 25 wt. %, about 10 wt. % to about 50 wt. % , about 10 wt. % to about 40 wt. %, or about 30 wt. % to about 50 wt. % polyamine or copolymer thereof based on the total weight of the hydrogel.

In one embodiment, the hydrogel may be a dry or dehydrated hydrogel. In this embodiment, the dry or dehydrated hydrogel may comprise between about 80 wt. % to about 99.9 wt. % polyamine or copolymer thereof based on the total weight of the dehydrated hydrogel.

In some embodiments, the polyamine or copolymer thereof has a weight average molecular weight (Mw) in the range of between about 100 g/mol to about 500,000 g/mol, for example between about 1,000 g/mol to about 2,500,000 g/mol. In some embodiments, the polyamine or copolymer thereof has a weight average molecular weight (Mw) of at least about 1,000, 5,000, 10,000, 50,000, 100,000, 150,000, 200,000, 250,000 or 500,000 g/mol. In other embodiments, the polyamine or copolymer thereof has a weight average molecular weight (Mw) of less than about 500,000, 250,000, 200,000, 150,000, 100,000, 50,000, 10,000, 5,000 or 1,000 g/mol. Combinations of these molecular weights to form various ranges are also possible, for example the polyamine or copolymer thereof has a weight average molecular weight (Mw) of between about 1,000 to about 250,000 g/mol, about 5,000 to about 50,000 g/mol, or 10,000 to about 30,000 g/mol. In some embodiments, the polyamine or copolymer thereof has a weight average molecular weight (Mw) of about 25,000 g/mol. It will be appreciated that these weight average molecular weights are provided for the polyamine or copolymer thereof prior to cross-linking. It will be appreciated that the weight average molecular weight of the polyamine or copolymer thereof may vary depending on the type used to prepare the hydrogel. In one embodiment, the polyamine or copolymer thereof may comprise a homopolymer or a copolymer. The weight average molecular weight can be determined using a variety of suitable techniques known to the person skilled in the art, for example gel permeation chromatography (GPC), size-exclusion chromatography (SEC) and light scattering. In one embodiment, the weight average molecular weight is determined size-exclusion chromatography (SEC).

In one embodiment, the Mw is determined using size exclusion chromatography (SEC) by passing a solution of the polyamine or copolymer thereof through a suitable column comprising a gel that separates the polyamine or copolymer thereof based on molecular size (i.e. hydrodynamic volumes which can be correlated with molecular weight), with larger size molecules (larger Mw) eluting first followed by smaller size molecules (smaller Mw). This can be performed in a suitable organic solvent or in aqueous media. The Mw is typically determined against a series of known polymer standards or using molar mass sensitive detectors. Suitable protocols for determining molecular weight of the polyamine or copolymer thereof are outlined in “Size-exclusion Chromatography of Polymers” Encyclopaedia of Analytical Chemistry, 2000, pp 8008-8034, incorporated herein by reference.

The acidic gas (e.g. CO₂ or H₂S) may be removed from the gaseous stream by being absorbed into a hydrogel. For example, the acidic gas may be absorbed into the hydrogel by a chemical or physical process. In some embodiments, the cross-linked polyamine or copolymer thereof comprise functional amine groups capable of binding to the acidic gas. For example, owing to its porous nature, on contact with the hydrogel, the a gaseous stream or atmosphere comprising the acidic gas can pass through the interstitial pores within the hydrogel and the acidic gas can react and bind to the functional groups on the polyamine or copolymer thereof. In some embodiments, the polyamine or copolymer thereof may comprise one or more functional groups capable of binding to the acidic gas. For example, the polyamine or copolymer thereof may comprise one or more amine groups, such as a primary amine (—NH₂) or secondary amine group (—NH—). Such amine groups are CO₂— and H₂S-phillic and readily react and bind with CO₂ and H₂S.

The hydrogel comprises a cross-linked polyamine or copolymer thereof. As understood in the art, a polyamine is an organic compound having two or more amine groups (e.g. primary —NH₂, secondary —NHR, and/or tertiary —NR₂ amine groups).

In some embodiments, the polyamine or copolymer thereof may comprise a liner, branched, or dendritic polyamine, derivative or copolymer thereof. A linear polyamine is defined as containing only primary amines, secondary amines, or both primary amines and secondary amines. By way of illustrative example only, the structure of one possible linear polyamine before crosslinking is provided below as Formula 1:

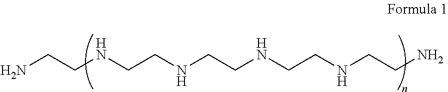

where n can be 1 to 10,000. In other examples, n may be at least 1, 10, 100, 200, 500, or 1000. In other examples, n may be less than 10,000, 9,000, 8,000, 7,000, 6,000, 5,000, 4,000, 3,000, 2,000, 1,000, 500, 200, or 100. In other examples, n may be a range provided by any two of these upper and/or lower values, for example 1 to 1000, 10 to 5,000, or 100 to 2000.

The ratio of secondary to primary amines in the linear polyamine of Formula 1 may be about 0.1 to 100. The ratio of secondary to primary amines in the linear polyamine of Formula 1 may be at least about 0.1, 0.5, 1, 2, 3, 4, 5, 6, 7, 8, 9, 10, 15, 20, 25, 30, 35, 40, 45, 50, 55, 60, 65, 70, 75, 80, 85, 90 or 95. The ratio of secondary to primary amines in the linear polyamine of Formula 1 may be less than about 100, 95, 90, 85, 80, 75, 70, 65, 60, 55, 50, 45, 40, 35, 30, 25, 20, 15, 10, 9, 8, 7, 6, 5, 4, 3, 2, 1, or 0.5. The ratio may be a range provided by any two of these upper and/or lower values.

A branched polyamine is defined as containing any number of primary (—NH₂), secondary (—NH—) and tertiary amines [symbol] . By way of illustrative example only, the structure of one possible branched polyamine before crosslinking is provided below as Formula 2 as follows:

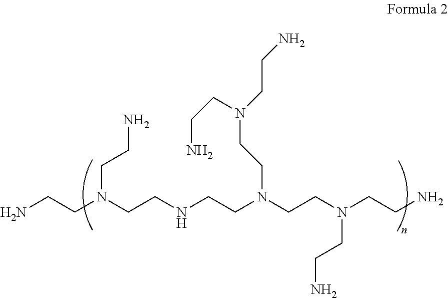

wherein n can be 1 to 10,000. In other examples, n may be at least 1, 10, 100, 200, 500, or 1000. In other examples, n may be less than 10,000, 9,000, 8,000, 7,000, 6,000, 5,000, 4,000, 3,000, 2,000, 1,000, 500, 200, or 100. In other examples, n may be a range provided by any two of these upper and/or lower values, for example 1 to 1000, 10 to 5,000, or 100 to 2000.

The ratio of primary to secondary to tertiary amine groups in the branched polyamine can be about 10:80:10 to 60:10:30, about 60:30:10 to 30:50:20, or about 45:45:10 to 35:45:20. The person skilled in the art would understand that the structures of branched polyamines can vary greatly depending on the number of tertiary amine groups present.

A dendritic polyamine is defined as containing only primary (—NH₂) and tertiary amines [symbol] , where groups of repeat units are arranged in a manner that is necessarily symmetric in at least one plane through the centre (core) of the polyamine, where each polymer branch is terminated by a primary amine, and where each branching point is a tertiary amine. The ratio of primary amine groups to tertiary amine groups in a dendritic polyamine may be about 1 to 3. By way of illustrative example only, the structure of one possible dendritic polyamine before crosslinking is provided below as Formula 3 as follows:

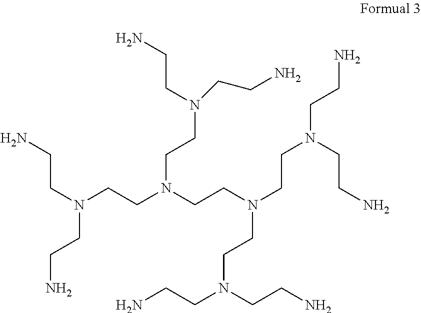 [SMILES: NCCN(CCN)CCN(CCN(CCN)CCN)CCN(CCN(CCN)CCN)CCN(CCN)CCN]

The polyamine or copolymer thereof may comprise a hyperbranched polyamine, derivative or copolymer thereof. A hyperbranched polyamine is defined as having a structure resembling dendritic polyamine, but containing defects in the form of secondary amines (—NH—) (e.g. linear subsections as would exist in a branched polyamine), in such a way that provides a random structure instead of a symmetric dendritic structure. In a hyperbranched structure, the ratio of primary to secondary to tertiary amine amines may be about 65:5:30 to 30:10:60.

In one embodiment, the polyamine, derivative or copolymer thereof may comprise between about 10 mol % to 70 mol % primary amine (—NH₂) groups, for example at least about 10, 20, 30, 40, 50 mol % primary amine groups. The polyamine, derivative or copolymer thereof may comprise between about 10 mol % to 70 mol % secondary amine (—NH—) groups, for example at least about 10, 20, 30, 40, 50 mol % secondary amine groups. The polyamine, derivative or copolymer thereof may comprise between about 1 mol % to about 10 mol % tertiary amine [symbol] groups, for example at least about 1, 2, 5 mol % tertiary amine groups. The ratio of primary to secondary to tertiary amine groups in the polyamine, derivative or copolymer thereof may be about 10:80:10 to 60:10:30, about 60:30:10 to 30:50:20, or about 45:45:10 to 35:45:20. In one embodiment, the polyamine may comprise at least one or more aliphatic amine groups (e.g. an amine wherein no aromatic ring groups are directly bound to the nitrogen atom of the amine).

In one embodiment, the polyamine or copolymer thereof comprises a branched polyamine, derivative or copolymer thereof. The polyamine, derivative or copolymer thereof can be cross-linked by one or more cross-linking agents described herein.

In one embodiment, the polyamine, derivative or copolymer thereof is a polyalkylenimine. The polyalkylenimine may be selected from the group consisting of polyethylenimine, polypropylenimine, and polyallylamine, derivatives or copolymers thereof. Suitable polyamines that can be used to form the hydrogel may include polyethylenimine, polypropylenimine, and polyallylamine. In one embodiment, the polyamine or copolymer thereof comprises polyethylenimine or a copolymer thereof. By using a hydrogel comprising a cross-linked polyamine (such as polyethylenimine), the hydrogel comprises a plurality of primary and secondary amine functional groups which are capable of reacting and binding to an acidic gas (e.g. CO₂ or H₂S) upon contact with a gaseous stream or atmosphere comprising the acidic gas.

In some embodiments, the cross-linked polyamine is swollen with one or more liquid swelling agents as described herein, for example water, alcohols, polyol compounds, glycols, amines (e.g. alkanolamines, alkylamines, alkyloxyamines), piperidines, piperazines, pyridines, pyrrolidones, and derivatives or combinations thereof. Suitable alkanolamines may include monoethanolamine, diethanolamine, methyldiethanolamine, diisopropanolamine, N-ethylmonoethanolamine and aminoethoxyethanol. Suitable glycols may include ethylene glycol, Triethylene glycol, monoethylene glycol, diethylene glycol, propylene glycol, propanediol, butylene glycol, polyethylene glycol, and diglyme. Suitable alcohols may include 2-ethyoxyethanol, 2-methoxyethanol. Suitable polyol compounds may include glycerol. Suitable piperidines include piperidine, 2-methylpiperidine, 3-methylpiperidine, 4-methylpiperidine, 2-piperidineethanol (PE), 3-piperidinemthanol, and 4-piperidinemethanol. The liquid swelling agent may comprise any one or more of the above liquids.

In some embodiments, the hydrogel comprises a cross-linked polyalkylenimine selected from the group consisting of polyethylenimine, polypropylenimine, and polyallylamine, or copolymer thereof, and is swollen with a liquid swelling agent selected from the group consisting of water, monoethanolamine, diethanolamine, methyldiethanolamine, dii sopropanolamine, N-ethylmonoethanolamine, aminoethoxyethanol, ethylene glycol, monoethylene glycol, diethylene glycol, triethylene glycol, propylene glycol, propanediol, butylene glycol, polyethylene glycol, glycerol, diglyme, 2-ethyoxyethanol, 2-methoxyethanol, glycerol, 2-methylpiperidine, 3-methylpiperidine, 4-methylpiperidine, 2-piperidineethanol (PE), 3-piperidinemthanol, and 4-piperidinemthanol, or a mixture thereof.

### Alkanol Substitution

The cross-linked polyamine or copolymer therof defined herein can be substituted with an optionally substituted alkanol group. It will be appreciated that the alkanol groups described herein form part of the “solid” cross-linked polyamine or copolymer thereof, and are distributed throughout the hydrogel together with the cross-linker. For example, the optionally substituted alkanol groups are grafted (i.e. attached) to the “solid” cross-linked polyamine. Of course, this does not preclude the hydrogel from being swollen with one or more liquid swelling agents, including for example water or a suitable alkanolamine.

According to some embodiments or examples described herein, the present inventors have identified that the substitution of one or more amine groups of the cross-liked polyamine or copolymer thereof with an optionally substituted alkanol can provide a hydrogel with good long term stability. For example, according to least according to some embodiments or examples described herein, the substitution of one or more primary amine groups of the cross-linked polyamine or copolymer thereof with an optionally substituted alkanol can minimize deactivation of the primary amine groups which can occur at the higher temperatures during regeneration (e.g. via steam or heating) due to urea formation between the amine and the liberated CO₂. By preventing or minimising such amine deactivation during regeneration, the regenerated hydrogel maintains good CO₂ absorption over repeated cycles thereby improving the overall stability and performance of the hydrogel.

In addition and according to at least some embodiments or examples described herein, the present inventors have identified that hydrogels comprising an alkanol substituted cross-linked polyamine or copolymer thereof can surprisingly increase the amount of CO₂ absorbed into the hydrogel, despite the reduction of the overall number of reactive amine groups available to bind to CO₂ as a result of the alkanol functionalising. Despite the cross-linker being distributed throughout the hydrogel also reducing the number of reactive amines, the hydrogel demonstrates good CO₂ absorption properties, as highlighted in the Examples and/or by one or more embodiments descried herein. Without wishing to be bound by theory, the improved absorption % may be due to increased hydrogen bonding sites and/or structural changes in the hydrogel that facilitate exchange with the gaseous stream. Additionally, the alkanol substitution may also improve the swelling characteristics and structural properties of the hydrogel which in some embodiments can assist in acidic gas uptake by improving contact between the gaseous stream or atmosphere and the hydrogel along with improving the overall gas permeability.

In one aspect or embodiment, there is provided a hydrogel comprising a cross-linked polyamine or copolymer thereof, wherein the cross-linked polyamine comprises one or more amine groups substituted with an optionally substituted alkanol group.

In another aspect or embodiment, there is provided a hydrogel comprising a cross-linked polyamine or copolymer thereof, wherein the cross-linked polyamine or copolymer thereof is a reaction product of:
a) a polyamine or copolymer thereof;
b) a functionalising epoxide; and
c) a cross-linking agent,
wherein the cross-linked polyamine or copolymer thereof of the reaction product comprises one or more amine groups substituted with an optionally substituted alkanol group.

In one embodiment, the cross-linked polyamine or copolymer thereof is a reaction product of:
a) an alkanol substituted polyamine or copolymer thereof, wherein the alkanol is optionally substituted; and
b) a cross-linking agent.

In another embodiment, the cross-linked polyamine or copolymer thereof is a reaction product of:
a) a cross-linked polyamine or copolymer thereof; and
b) a functionalising epoxide.

It will be appreciated that the cross-linked polyamine or copolymer thereof has an amine group distribution. The cross-linked polyamine or copolymer thereof may comprise a mixture of primary (1º) amine —NH₂, secondary (1º) amine —NHR and/or -tertiary (1º) amine —NR₂) groups. The amine group distribution is the % distribution of the amine state within the cross-linked polyamine or copolymer thereof. The amine group distribution can be readily measured using ¹³ C NMR.

In one embodiment, the alkanol substitution provides a cross-linked polyamine or copolymer thereof having an amine group distribution comprising a lower number of primary (1º) amine groups compared to the amine group distribution of a non alkanol substituted cross-linked polyamine or copolymer thereof. It will be appreciated that a reduction in the number of primary (1º) amine groups corresponds to a corresponding increase in the number of secondary (2º) amine groups due to the functionalisation with the optionally substituted alkanol (e.g. conversion of a primary amine group into a secondary amine group).

In some embodiments, the alkanol substitution provides a cross-linked polyamine or copolymer thereof having an amine group distribution comprising between about 1% to about 50% primary amine groups. In some embodiments, the alkanol substitution provides a cross-linked polyamine or copolymer thereof having an amine group distribution comprising less than about 50%, 45%, 40%, 35%, 30%, 25%, 20%, 15%, 10%, 5%, 4%, 3%, 2% or 1% of 1º amine groups. In some embodiments, the alkanol substitution provides a cross-linked polyamine or copolymer thereof having an amine group distribution comprising greater than about 1%, 2%, 3%, 4%, 5%, 10%, 15%, 20%, 25%, 30%, 35%, 40%, or 50% of 1º amine groups. Combinations of these primary amine percentages to form various ranges are also possible, for example between about 5% to about 20% of 1º amine groups.

In some embodiments, the alkanol substitution provides a cross-linked polyamine or copolymer thereof having an amine group distribution comprising a secondary (2º):primary (1º) amine ratio of between about 1 to about 50. In some embodiments, the alkanol substitution provides a cross-linked polyamine or copolymer thereof having an amine group distribution comprising a secondary (2º):primary (1º) amine ratio of at least 1, 2, 3, 4, 5, 8, 10, 12, 14, 16, 18, 20, 25, 30, 35, 40, 45 or 50. In some embodiments, the alkanol substitution provides a cross-linked polyamine or copolymer thereof having an amine group distribution comprising a secondary (2º):primary (1º) amine ratio of less than about 50, 45, 40, 35, 30, 25, 20, 18, 16, 14, 12, 10, 8, 5, 4, 3, 2 or 1. Combinations of these ratios to form various ranges are also possible, for example between about 1 to about 40, about 1 to 20, or about 1 to 10.

In some embodiments, the alkanol substitution provides a cross-linked polyamine or copolymer thereof having an amine group distribution comprising a secondary (2º):tertiary (3º) amine ratio of between about 1 to about 20. In some embodiments, the alkanol substitution provides a cross-linked polyamine or copolymer thereof having an amine group distribution comprising a secondary (2º) :tertiary (3º) amine ratio of at least 1, 2, 3, 4, 5, 8, 10, 12, 14, 16, 18 or 20. In some embodiments, the alkanol substitution provides a cross-linked polyamine or copolymer thereof having an amine group distribution comprising a secondary (2º) :tertiary (3º) amine ratio of less than about 20, 18, 16, 14, 12, 10, 8, 5, 4, 3, 2 or 1. Combinations of these ratios to form various ranges are also possible, for example between about 1 to about 10.

In some embodiments, the alkanol substitution provides a cross-linked polyamine or copolymer thereof having an amine group distribution comprising a tertiary (3°):primary (1º) amine ratio of between about 1 to about 30. In some embodiments, the alkanol substitution provides a cross-linked polyamine or copolymer thereof having an amine group distribution comprising a tertiary (3º):primary (1º) amine ratio of at least 1, 2, 3, 4, 5, 8, 10, 12, 14, 16, 18, 20, 25 or 30. In some embodiments, the alkanol substitution provides a cross-linked polyamine or copolymer thereof having an amine group distribution comprising a tertiary (3º):primary (1º) amine ratio of less than about 30, 25, 20, 18, 16, 14, 12, 10, 8, 5, 4, 3, 2 or 1. Combinations of these ratios to form various ranges are also possible, for example between about 1 to about 20.

In some embodiments, the alkanol substitution provides a cross-linked polyamine or copolymer thereof having an amine group distribution comprising a primary (1º):secondary (2º):tertiary (3º) amine ratio of between about 1:1:0.5 to about 1:50:30, for example between about 1:2:1.5 to about 1:30:20, e.g. between about 1:1:1.5 to about 1:30:18.

According to some embodiments or examples, the present inventors have identified that the epoxide functionalising agent preferentially functionalises at primary amine groups on the cross-linked polyamine or copolymer thereof to form secondary amine groups which are substituted with the optionally substituted alkanol group. Such a preferential functionalisation of primary amines to secondary amines (as opposed to secondary amines to tertiary amines) maintained the hydrogels good CO₂ absorption and regeneration properties. In contrast, non-functionali sed hydrogels comprising unsubstituted primary amine groups can be deactivated via urea formation under regenerative conditions. By increasing the number of secondary amine groups present within the hydrogel whilst keeping the number of tertiary amine groups low, good absorption and regeneration properties can be achieved. The amine group distribution also can be used to determine the uptake kinetics of the acidic gas and stability of the hydrogel. The present inventors have identified that the hydrogels of the present disclosure can be tuned to balance both uptake kinetics and stability by functionalisation of the amine groups of the cross-linked polyamine or copolymer thereof with an optionally substituted alkanol.

In one embodiment, the alkanol is a monohydroxyalkanol, which may be further substituted or unsubstituted as described herein. In other words, the alkanol may comprise or have a single hydroxyl (—OH) group sub stituent.

### Hydroxyethyl Group

The optionally substituted alkanol group may be an optionally substituted hydroxyethyl group. The hydroxyethyl group may be the reaction product between an amine group of the polyamine or copolymer thereof and an epoxide functionalising agent. In some embodiments, the hydroxyethyl group may be substituted with any suitable hydrophobic moiety.

In one embodiment, the optionally substituted hydroxyethyl group has a structure of Formula I:

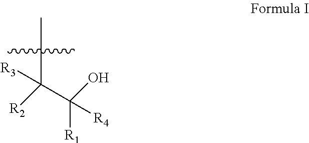

wherein:
R₁ to R₄ are each independently selected from hydrogen or an optionally substituted alkyl, alkenyl, alkynyl, alkoxy, cycloalkyl, aryl, heteroalkyl or heterocyclyl, or R₁ or R₄, together with R₂ or R₃, form an optionally substituted cycloalkyl, aryl or heterocyclyl; and
[symbol] represents an attachment point on the one or more amino groups of the cross-linked polyamine or copolymer thereof.

R₁ to R₄ may each be independently selected from hydrogen or alkyl, alkenyl, alkynyl, alkoxy, cycloalkyl, aryl, heteroalkyl or heterocyclyl, or R₁ or R₄, together with R₂ or R₃, form a cycloalkyl, aryl or heterocyclyl, wherein each alkyl, alkenyl, alkynyl, alkoxy, cycloalkyl, aryl, heteroalkyl or heterocyclyl is unsubstituted or substituted with one or more substituents selected from the group consisting of halogen, —OR′, —SR′, —NR′R′, —NO₂, —CN, —C(O)R′, —C(O)OR′, —C(O)NR′R′, —C(NR′)NR′R′, alkyl, alkenyl, alkynyl, cycloalkyl, aryl, heteroalkyl or heterocycl; wherein each R′ is independently selected from the group consisting of hydrogen, alkyl, heteroalkyl, alkenyl, alkynyl, C₃₋₁₀carbocyclyl, and C₃₋₁₀heterocyclyl.

R₁ to R₄ may each be independently selected from hydrogen or C₁₋₂₀alkyl, C₂₋₂₀alkenyl, C₂₋₂₀alkynyl, C₁₋₂₀alkoxy, C₃₋₂₀cycloalkyl, C₃₋₂₀aryl, C₁₋₂₀heteroalkyl or C₃₋₂₀heterocyclyl, or R₁ or R₄, together with R₂ or R₃, form a C₃₋₂₀cycloalkyl, C₃₋₂₀aryl or C₃₋₂₀heterocyclyl, wherein each alkyl, alkenyl, alkynyl, alkoxy, cycloalkyl, aryl, heteroalkyl or heterocyclyl is unsubstituted or substituted with one or more substituents selected from the group consisting of halogen, —OR′, —SR′, —NR′R′, —NO₂, —CN, —C(O)R′, —C(O)OR′, —C(O)NR′R′, —C(NR′)NR′R′, alkyl, alkenyl, alkynyl, cycloalkyl, aryl, heteroalkyl or heterocycl; wherein each R′ is independently selected from the group consisting of hydrogen, alkyl, heteroalkyl, alkenyl, alkynyl, 3-10-membered carbocycle, and 3-10-membered heterocycle.

R₁ to R₄ may each be independently selected from hydrogen or C₁₋₁₀alkyl, C₂₋₁₀alkenyl, C₂₋₁₀alkynyl, C₁₋₁₀alkoxy, C₃₋₁₀cycloalkyl, C₃₋₁₀aryl, C₁₋₁₀heteroalkyl or C₃₋₁₀heterocyclyl, or R₁ or R₄, together with R₂ or R₃, form a C₃₋₁₀cycloalkyl, C₃₋₁₀aryl or C₃₋₁₀heterocyclyl, wherein each alkyl, alkenyl, alkynyl, alkoxy, cycloalkyl, aryl, heteroalkyl or heterocyclyl is unsubstituted or substituted with one or more substituents selected from the group consisting of halogen, —OR′, —SR′, —NR′R′, —NO₂, —CN, —C(O)R′, —C(O)OR′, —C(O)NR′R′, —C(NR′)NR′R′, alkyl, alkenyl, alkynyl, cycloalkyl, aryl, heteroalkyl or heterocycl; wherein each R′ is independently selected from the group consisting of hydrogen, alkyl, heteroalkyl, alkenyl, alkynyl, C₃₋₁₀carbocyclyl, and C₃₋₁₀heterocyclyl.

In one embodiment, the optionally substituted hydroxyethyl group has a structure of Formula Ia:

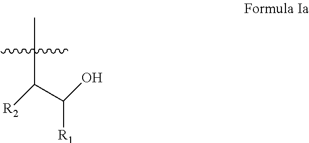

R₁ and R₂ are each independently selected from hydrogen or an optionally substituted alkyl, alkenyl, alkynyl, alkoxy, cycloalkyl, aryl, heteroalkyl or heterocyclyl or R₁ and R₂ together form an optionally substituted cycloalkyl, aryl or heterocyclyl; and

[symbol] represents an attachment point on the one or more amino groups of the cross-linked polyamine or copolymer thereof.

R₁ and R₂ may each be independently selected from hydrogen or alkyl, alkenyl, alkynyl, alkoxy, cycloalkyl, aryl, heteroalkyl or heterocyclyl, wherein each alkyl, alkenyl, alkynyl, alkoxy, cycloalkyl, aryl, heteroalkyl or heterocyclyl is unsubstituted or substituted with one or more sub stituents selected from the group consisting of halogen, —OR′, —SR′, —NR′R′, —NO₂, —CN, —C(O)R′, —C(O)OR′, —C(O)NR′R′, —C(NR′)NR′R′, alkyl, alkenyl, alkynyl, cycloalkyl, aryl, heteroalkyl or heterocycl; wherein each R′ is independently selected from the group consisting of hydrogen, alkyl, heteroalkyl, alkenyl, alkynyl, C₃₋₁₀carbocyclyl, and C₃₋₁₀heterocyclyl.

R₁ and R₂ may each be independently selected from hydrogen or C₁₋₂₀alkyl, C₂₋₂₀alkenyl, C₂₋₂₀alkynyl, C₁₋₂₀alkoxy, C₃₋₂₀cycloalkyl, C₃₋₂₀aryl, C₁₋₂₀heteroalkyl or C₃₋₂₀heterocyclyl, wherein each alkyl, alkenyl, alkynyl, alkoxy, cycloalkyl, aryl, heteroalkyl or heterocyclyl is unsubstituted or substituted with one or more substituents selected from the group consisting of halogen, —OR′, —SR′, —NR′R′, —NO₂, —CN, —C(O)R′, —C(O)OR′, —C(O)NR′R′, —C(NR′)NR′R′, alkyl, alkenyl, alkynyl, cycloalkyl, aryl, heteroalkyl or heterocycl; wherein each R′ is independently selected from the group consisting of hydrogen, alkyl, heteroalkyl, alkenyl, alkynyl, 3-10-membered carbocycle, and 3-10-membered heterocycle.

R₁ and R₂ may each be independently selected from hydrogen or C₁₋₁₀alkyl, C₂₋₁₀alkenyl, C₂₋₁₀alkynyl, C₁₋₁₀alkoxy, C₃₋₁₀cycloalkyl, C₃₋₁₀aryl, C₁₋₁₀heteroalkyl or C₃₋₁₀heterocyclyl, wherein each alkyl, alkenyl, alkynyl, alkoxy, cycloalkyl, aryl, heteroalkyl or heterocyclyl is unsubstituted or substituted with one or more substituents selected from the group consisting of halogen, —OR′, —SR′, —NR′R′, —NO₂, —CN, —C(O)R′, —C(O)OR′, —C(O)NR′R′, —C(NR′)NR′R′, alkyl, alkenyl, alkynyl, cycloalkyl, aryl, heteroalkyl or heterocycl; wherein each R′ is independently selected from the group consisting of hydrogen, alkyl, heteroalkyl, alkenyl, alkynyl, C₃₋₁₀carbocyclyl, and C₃₋₁₀heterocyclyl.

In one embodiment, the optionally substituted hydroxyethyl group has a structure of Formula Ib or Formula Ic:

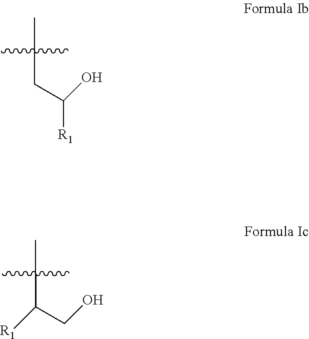

wherein:
R₁ is selected from hydrogen or an optionally substituted C₁₋₁₀alkyl, C₂₋₁₀alkenyl, C₂₋₁₀alkynyl, C₁₋₁₀alkoxy, C₃₋₁₀cycloalkyl, C₃₋₁₀aryl, C₁₋₁₀heteroalkyl or C₃₋₁₀heterocyclyl; and
[symbol] represents an attachment point on the one or more amino groups of the cross-linked polyamine or copolymer thereof.

R₁ may be selected from hydrogen or alkyl, alkenyl, alkynyl, alkoxy, cycloalkyl, aryl, heteroalkyl or heterocyclyl, wherein each alkyl, alkenyl, alkynyl, alkoxy, cycloalkyl, aryl, heteroalkyl or heterocyclyl is unsubstituted or substituted with one or more substituents selected from the group consisting of halogen, —OR′, —SR′, —NR′R′, —NO₂, —CN, —C(O)R′, —C(O)OR′, —C(O)NR′R′, —C(NR′)NR′R′, alkyl, alkenyl, alkynyl, cycloalkyl, aryl, heteroalkyl or heterocycl; wherein each R′ is independently selected from the group consisting of hydrogen, alkyl, heteroalkyl, alkenyl, alkynyl, C₃₋₁₀carbocyclyl, and C₃₋₁₀heterocyclyl.

R₁ may be selected from hydrogen or C₁₋₂₀alkyl, C₂₋₂₀alkenyl, C₂₋₂₀alkynyl, C₁₋₂₀alkoxy, C₃₋₂₀cycloalkyl, C₃₋₂₀aryl, C₁₋₂₀heteroalkyl or C₃₋₂₀heterocyclyl, wherein each alkyl, alkenyl, alkynyl, alkoxy, cycloalkyl, aryl, heteroalkyl or heterocyclyl is unsubstituted or substituted with one or more substituents selected from the group consisting of halogen, —OR′, —SR′, —NR′R′, —NO₂, —CN, —C(O)R′, —C(O)OR′, —C(O)NR′R′, —C(NR′)NR′R′, alkyl, alkenyl, alkynyl, cycloalkyl, aryl, heteroalkyl or heterocycl; wherein each R′ is independently selected from the group consisting of hydrogen, alkyl, heteroalkyl, alkenyl, alkynyl, 3-10-membered carbocycle, and 3-10-membered heterocycle.

R₁ may be selected from hydrogen or C₁₋₁₀alkyl, C₂₋₁₀alkenyl, C₂₋₁₀alkynyl, C₁₋₁₀alkoxy, C₃₋₁₀cycloalkyl, C₃₋₁₀aryl, C₁₋₁₀heteroalkyl or C₃₋₁₀heterocyclyl, wherein each alkyl, alkenyl, alkynyl, alkoxy, cycloalkyl, aryl, heteroalkyl or heterocyclyl is unsubstituted or substituted with one or more substituents selected from the group consisting of halogen, —OR′, —SR′, —NR′R′, —NO₂, —CN, —C(O)R′, —C(O)OR′, —C(O)NR′R′, —C(NR′)NR′R′, alkyl, alkenyl, alkynyl, cycloalkyl, aryl, heteroalkyl or heterocycl; wherein each R′ is independently selected from the group consisting of hydrogen, alkyl, heteroalkyl, alkenyl, alkynyl, C₃₋₁₀carbocyclyl, and C₃₋₁₀heterocyclyl.

R₁ may be selected from hydrogen or C₁₋₂₀alkyl, C₁₋₁₀alkyl or C₁₋6alkyl, wherein each alkyl, alkenyl, alkynyl, alkoxy, cycloalkyl, aryl, heteroalkyl or heterocyclyl is unsubstituted or substituted with one or more substituents selected from the group consisting of halogen, —OR′, —SR′, —NR′R′, —NO₂, —CN, —C(O)R′, —C(O)OR′, —C(O)NR′R′, —C(NR′)NR′R′, alkyl, alkenyl, alkynyl, cycloalkyl, aryl, heteroalkyl or heterocycl; wherein each R′ is independently selected from the group consisting of hydrogen, alkyl, heteroalkyl, alkenyl, alkynyl, C₃₋₁₀carbocyclyl, and C₃₋₁₀heterocyclyl. The alkyl may be as defined herein, and may include for example methyl, ethyl, n-propyl. n-butyl, n-pentyl, isobutyl, t-butyl, isopropyl, hexyl.

In some embodiments, the optionally substituted alkanol is C₁₋₁₀alkylhydroxyl, for example a 2-ethyl-hydroxyethyl group (—CH₂CH(C₂H₅)OH) (which can also be called 2-hydroxybutane). It will be appreciated that this can be the reaction product of 1,2-epoxybutane (also known as 1,2-butylene oxide) with an amine group of the cross-linked polyamine or copolymer thereof, for example via an amine-epoxy addition.

According to some embodiments or examples described herein, the inventors have identified that functionalising one or more amine groups of the cross-linked polyamine with the electron-withdrawing hydroxyethyl group substituted can lower the amine groups basicity, which can result in the weakened interaction with the acidic gas (e.g. CO₂) allowing for easier regeneration. Furthermore, substituted hydroxyethyl groups (e.g. 2-ethyl-hydroxyethyl groups) can also increase the steric hindrance near the reactive nitrogen of the amine groups which can retard urea formation and/or destabilize the carbamate species formed after CO₂ absorption resulting in more facile regeneration.

### Cross-Linker and Cross-Linking Agent

The hydrogel comprises a cross-linked polyamine or copolymer thereof. It will be understood that some degree of cross-linking of the polyamine or copolymer thereof is required to form the hydrogel. The rigidity and elasticity of the hydrogel can be tailored by altering the degree of cross-linking. The cross-linker promotes the formation of the 3D “solid” polymeric network, making it insoluble. The insolubilized cross-linked polymeric network allows for the adoption and retention of water and other liquids. An overview of cross-linked hydrogels is discussed in Maitra et al., American Journal of Polymer Science, 2014, 4(2), 25-31, which is incorporated herein by reference.

As used herein, the term “cross-link, “cross-linked” or “cross-linking” refers to the formation of interactions within or between the polyamine or copolymer thereof which result in the formation of a “solid” three-dimensional matrix. i.e. a hydrogel. In other words, the cross-linked polyamine is distributed throughout the hydrogel. In one embodiment, the hydrogel comprises a cross-linked polyamine or copolymer thereof, wherein the cross-linked polyamine is distributed throughout the hydrogel and comprises one or more amine groups substituted with an optionally substituted alkanol group.

For example, the polyamine or copolymer thereof may be cross-linked by 1,3-butadiene diepoxide (BDDE) or triglycidyl trimethylolpropane ether (TTE or TMPTGE) to form a cross-linked polyamine hydrogel.

In some embodiments, the polyamine or copolymer thereof comprises about 0.01 mol % to about 50 mol % cross-linking agent. The polyamine or copolymer thereof may comprise at least about 0.01, 0.1, 1, 2, 5, 10, 15, 20, 25, 30, 35, 40, 45, or 50 mol % cross-linking agent. The polyamine or copolymer thereof may comprise less than about 50, 45, 40, 35, 30, 25, 20, 15, 10, 5, 2, 1, 0.1 or 0.01 mol % cross-linking agent. Combinations of these mol % values to form various ranges are also possible, for example the polyamine or copolymer thereof may comprise between about 0.01 mol % to about 50 mol %, about 0.01 mol % to about 20 mol %, or about 0.01 mol % to about 10 mol % cross-linking agent.

In some embodiments, the hydrogel comprises between about 1 wt. % to about 20 wt. % cross-linking agent based on the total weight of the hydrogel. In some embodiments, the hydrogel comprises at least about 1, 2, 3, 4, 5, 6, 8, 10, 15 or 20 wt. % cross-linking agent based on the total weight of the hydrogel. In other embodiments, the hydrogel comprises less than about 20, 15, 20, 15, 10, 8, 6, 5, 3, 2, or 1 wt. % cross-linking agent based on the total weight of the hydrogel. Combinations of these wt. % values to form various ranges are also possible, for example the hydrogel in a non-swollen state comprises between about 1 wt. % to about 10 wt. %, or between about 1 wt. % to about 6 wt. % cross-linking agent based on the total weight of the hydrogel.

Accordingly, in some embodiments, the hydrogel comprises between about 0.05 wt. % to about 50 wt. % cross-linked polyamine or copolymer thereof based on the total weight of the hydrogel. In some embodiments, the hydrogel comprises at least about 0.01, 0.05, 0.1, 0.2, 0.5, 1, 2, 5, 10, 15, 20, 25, 30, 35, 40, 45, or 50 wt. % cross-linked polyamine or copolymer thereof based on the total weight of the hydrogel. In other embodiments, the hydrogel comprises less than about 50, 45, 40, 35, 30, 25, 20, 15, 10, 5, 2, 1, 0.5, 0.2, 0.1, 0.05 or 0.01 wt. % cross-linked polyamine or copolymer thereof based on the total weight of the hydrogel. Combinations of these cross-linked polyamine or copolymer thereof to form various ranges are also possible, for example the hydrogel comprises between about 0.01 wt. % to about 50 wt. %, about 0.05 wt. % to about 50 wt. %, about 1 wt. % to about 50 wt. %, about 0.05 wt. % to about 25 wt. %, about 10 wt. % to about 50 wt. % , about 10 wt. % to about 40 wt. %, or about 30 wt. % to about 50 wt. % cross-linked polyamine or copolymer thereof based on the total weight of the hydrogel.

In one embodiment, the dry or dehydrated hydrogel may comprise between about 80 wt. % to about 99.9 wt. % cross-linked polyamine or copolymer thereof based on the total weight of the dehydrated hydrogel.

The swelling ability of the hydrogel is dependent on the nature of the cross-linked polyamine or copolymer thereof and the solvent that is swelling the hydrogel. For example, a hydrogel with long hydrophilic cross-links may swell more than an analogous cross-linked polymer network with shorter hydrophobic cross-links.

The cross-linking agent may be selected to provide an alkyl cross-linker, heteroalkyl cross-linker, cycloalkyl cross-linker, arylalkyl cross-linker, or heteroarylalkyl cross-linker, in the cross-linked polyamine or copolymer thereof, each of which may be optionally substituted and/or optionally interrupted as described herein. The cross-linking agent may comprise between about 1 and 30 carbon atoms and may be optionally substituted and/or optionally interrupted as described herein.

In some embodiments, the cross-linking agent is selected to provide an alkyl cross-linker in the cross-linked polyamine or copolymer thereof. The alkyl cross-linker may be optionally substituted with one or more functional groups selected from alkyl, halo, haloalkyl, hydroxyl, or amine, and optionally interrupted with one or more O, N, Si or S. In one example, the cross-linker is substituted with one or more hydroxyl groups. The presence of one or more hydroxyl groups on the cross-linker can further improve the binding and absorption of an acidic gas (e.g. CO₂) in the hydrogel, at least according to some examples as described herein.

In some embodiments, the cross-linking agent may be selected to provide a C₁-C₂₀alkyl cross-linker in the cross-linked polyamine or copolymer thereof. It will be appreciated that the C₁₋₂₀alkyl cross-linker may be provided by any alkyl as described above or herein having a 1 to 20 atom chain. For example, the C₁₋₂₀alkyl cross-linker may be optionally substituted with one or more functional groups selected from at least alkyl, halo, haloalkyl, hydroxyl, or amine, and optionally interrupted with one or more O, N, Si or S. In other examples the cross-linking agent may be a C₂-C₂₀alkyl, C₅-C₂₀alkyl, C₁₀-C₂₀alkyl or C₁₂-C₁₀alkyl, according to any example as described herein.

In some embodiments, the cross-linking agent may be selected to provide a C₁-C₁₀alkyl cross-linker in the cross-linked polyamine or copolymer thereof. It will be appreciated that the C₁₋₁₀alkyl cross-linker may be provided by any alkyl as described above or herein having a 1 to 10 atom chain. For example, the C₁₋₁₀alkyl cross-linker may be optionally substituted with one or more functional groups selected from at least alkyl, halo, haloalkyl, hydroxyl, or amine, and optionally interrupted with one or more O, N, Si or S. In other examples the cross-linking agent may be a C₂-C₁₀alkyl, C₃-C₁₀alkyl, C₄-C₁₀alkyl or C₅-C₁₀alkyl, according to any example as described herein.

The cross-linking agent may be selected to provide a heteroalkyl cross-linker in the cross-linked polyamine or copolymer thereof. The heteroalkyl group may be provided by an alkyl as described herein or any example thereof, which is interrupted by one or more heteroatoms (e.g. 1 to 3). The heteroatoms may be selected from any one or more of O, N, Si, S.

The cross-linking agent may be selected to provide a cycloalkyl cross-linker in the cross-linked polyamine or copolymer thereof. The cycloalkyl cross-linker may be optionally substituted with one or more functional groups selected from alkyl, halo, haloalkyl, hydroxyl, or amine, and optionally interrupted with one or more O, N, Si or S. The cycloalkyl group may be an alkylcycloalkyl group, for example. The cycloalkyl group may have 1-3 cyclic groups linked and/or fused together.

The cross-linking agent may be selected to provide an arylalkyl cross-linker in the cross-linked polyamine or copolymer thereof. The arylalkyl cross-linker may be optionally substituted with one or more functional groups selected from any one or more of halo, haloalkyl, hydroxyl, carboxyl, or amine, and optionally interrupted with any one or more O, N, Si or S. The arylalkyl cross-linker may have 1 to 3 aryl groups, for example, each of which may be linked and/or fused together.

The cross-linking agent may be selected to provide a heteroarylalkyl cross-linker in the cross-linked polyamine or copolymer thereof. It will be appreciated that the heteroarylalkyl may be any arylalkyl group that is interrupted by one or more heteroatoms. The heteroatoms may be selected from any one or more of O, N, Si, S.

In some embodiments, the cross-linking agent is an epoxide (i.e. an epoxide cross-linker). For example, the epoxide can provide a bivalent or polyvalent linking group in the cross-linked polyamine or copolymer thereof, which may comprise one or more hydroxyl groups arising from reaction of the epoxide groups with the polyamine or copolymer thereof. In some embodiments, the cross-linking agent comprises at least 2, 3, 4 or 5 epoxides. In some embodiments, the cross-linking agent comprises 2 epoxides. In one embodiment, the cross-linking agent is an epoxide. In one embodiment the epoxide is a diepoxide (e.g. comprises 2 epoxide groups, for example BDDE). In one embodiment, the epoxide is a triepoxide (e.g. comprises 3 epoxide groups, for example TTE). In one embodiment, the cross-linking agent is 1,3-butadiene diepoxide (BDDE) or triglycidyl trimethylolpropane ether (TTE or TMPTGE).

The cross-linking agent may be selected from the group consisting of triglycidyl trimethylolpropane ether (TTE or TMPTGE) (also referred to as trimethylolpropane triglycidyl ether), diglycidyl ether, Resorcinol diglycidyl ether (CAS Number: 101-90-6), Bisphenol A diglycidyl ether, 1,3-Butadiene diepoxide, Diglycidyl 1,2-cyclohexanedicarboxylate, Diglycidyl hexahydrophthalate, Poly(ethylene glycol) diglycidyl ether average (<Mn 1000), Glycerol diglycidyl ether, 1,4-Butanediol diglycidyl ether, Bisphenol F diglycidyl ether, Bisphenol A propoxylate diglycidyl ether, Bisphenol A propoxylate diglycidyl ether PO/phenol 1, N,N-Diglycidyl-4-glycidyloxyaniline, N,N-Diglycidyl-4-glycidyloxyaniline, Poly(dimethylsiloxane), diglycidyl ether terminated (Mn<1000), Neopentyl glycol diglycidyl ether, 2,2-Bis[4-(glycidyloxy)phenyl]propane, 4,4′-Isopropylidenediphenol diglycidyl ether, BADGE, Bisphenol A diglycidyl ether, D.E.R.™ 332, Bis[4-(glycidyloxy)phenyl]methane, Tris(4-hydroxyphenyl)methane triglycidyl ether, Tris(2,3-epoxypropyl) isocyanurate, 4,4′-Methylenebis(2-methylcyclohexylamine). Other suitable cross linking agents may also comprise one or more isothiocyanates, isocyanates, acyl azides, NHS esters, sulfonyl chlorides, aldehydes, glyoxals, epoxides, oxiranes, carbonates, aryl halides, imidoesters, carbodiimides, anhydrides, and fluorophenyl ester groups.

The cross-linking agent may comprise an aldehyde group, for example at least one, two, or three aldehyde groups. For example, the cross-linking agent may be formaldehyde or glutaraldehyde.

The cross-linking agent may comprise two or more vinyl groups (—C═CH₂). For example, the cross-linking agent may be a divinyl cross-linking agent, such as N,N-methylenebisacrylamide or ethyleneglycol dimethacrylate. Other suitable cross-linking agents include ethylene glycol dimethacrylate and piperazine diacrylamide.

In one embodiment, the cross-linking agent is a diepoxide and the functionalising epoxide is a monoepoxide.

### Processes for Preparing Hydrogels

The present disclosure also provides a process for preparing the hydrogels described herein. The process may comprise mixing a solution comprising a polyamine or copolymer thereof, a cross-linking agent and a functionalising epoxide at a temperature and for a period of time effective to cross-link the polyamine or copolymer thereof to form the hydrogel. One or more one or more amine groups of the polyamine or copolymer thereof is functionalised by the epoxide to form the optionally substituted alkanol group. The functionalising epoxide is used to tune the amine group distribution of the cross-linked polyamine or copolymer thereof (e.g. decrease the number of primary amine groups compared to the number of secondary and/or tertiary amine groups present on the cross-linked polyamine or copolymer thereof). The polyamine or copolymer thereof, cross-linking agent, and optionally substituted alkanol group are described herein.

In some embodiments, the functionalising epoxide is mixed with the solution comprising the polyamine or copolymer thereof to form the optionally substituted alkanol group prior to addition of the cross-linking agent. In other embodiments, the functionalising epoxide is mixed with the cross-linking agent prior to addition of the solution comprising the polyamine or copolymer thereof.

In one embodiment, the process comprises 1) preparing a solution comprising the cross-linking agent and functionalising epoxide; and 2) mixing a solution comprising the polyamine or copolymer thereof with the solution comprising the cross-linking agent and functionalising epoxide to form the hydrogel, wherein one or more one or more amine groups of the polyamine or copolymer thereof is functionalised by the epoxide to form the optionally substituted alkanol group. In another embodiment, the process comprises: 1) preparing a solution comprising the polyamine or copolymer thereof and functionalising epoxide, wherein one or more one or more amine groups of the polyamine or copolymer thereof is functionalised by the epoxide to form an alkanol substituted polyamine or copolymer thereof, wherein the alkanol is optionally substituted; and 2) mixing a solution comprising the cross-linking agent with the solution comprising the alkanol substituted polyamine or copolymer thereof to form the hydrogel. In one embodiment, the cross-linking of the polyamine and alkanol functionalisation occurs in-situ.

In another embodiment, the process comprises: 1) preparing a solution comprising the polyamine or copolymer thereof and cross-linking agent to form a cross-linked polyamine or copolymer thereof; and 2) mixing a solution comprising the functionalising epoxide with the solution comprising the cross-linked polyamine or copolymer thereof to form the hydrogel, wherein one or more one or more amine groups of the polyamine or copolymer thereof is functionalised by the epoxide to form the optionally substituted alkanol group. In one embodiment, the cross-linking of the polyamine and alkanol functionalisation occurs ex-situ.

The polyamine or copolymer thereof, cross-linking agent and functionalising epoxide may be mixed at a suitable temperature. In one embodiment, the polyamine or copolymer thereof, cross-linking agent and functionalising epoxide may be mixed at a temperature of between about 0° C. to about 100° C. The polyamine or copolymer thereof, cross-linking agent and functionalising epoxide may be mixed at a temperature of at least about 0, 5, 10, 12, 15, 17, 20, 22, 25, 28, 30, 35, 40, 45, 50, 55, 60, 65, 70, 75, 80, 85, 90, 95 or 100° C. The polyamine or copolymer thereof, cross-linking agent and functionalising epoxide may be mixed at a temperature of less than about 100, 95, 90, 85, 80, 75, 70, 65, 60, 55, 50, 45, 40, 35, 30, 28, 25, 22, 20, 17, 15, 12, 10, or 5° C. The mixing temperature may be in a range provide by any two of these upper and/or lower values, for example between about 10° C. to about 100° C., for example between about 10° C. to about 50° C. In some embodiments, the mixing temperature is about about 10, 12, 15, 17, 20, 22, 25, 28, 30, 35, 40, 45 or 50° C. The mixing temperature may also be a temperature effective to evaporate the solution comprising the comprising the polyamine or copolymer thereof, cross-linking agent and/or functionalising epoxide.

The polyamine or copolymer thereof, cross-linking agent and functionalising epoxide are mixed for a period of time. In one embodiment, the polyamine or copolymer thereof, cross-linking agent and functionalising epoxide are mixed for a period of time of about 60 min to about 48 hours. In some embodiments, the polyamine or copolymer thereof, cross-linking agent and functionalising epoxide are mixed for a period of time of at least about 1, 6, 12, 24, 30, 46, 42 or 48 hours. In some embodiments, the polyamine or copolymer thereof, cross-linking agent and functionalising epoxide 48, 42, 46, 30, 24, 12, 6 or 1 hours. The mixing time may be in a range provide by any two of these upper and/or lower values.

In one embodiment, the process further comprises the step of grinding the hydrogel to form a plurality of hydrogel particles. Any suitable technique can be used to ground the hydrogel, for example using a mortar and pestle. The hydrogel may have a particle size as described herein.

In one embodiment, the process further comprises the step of dehydrating the hydrogel to remove the solution (e.g. the solution used to mix the polyamine or copolymer thereof, cross-linking agent and/or functionalising epoxide). In a further embodiment, the dehydrated hydrogel may be swollen with one or more of the liquid swelling agents described herein. Alternatively, the hydrogel may be prepared using one or more of the liquid swelling agents described herein.

In some embodiments, the solution comprising the polyamine or copolymer thereof, cross-linking agent and/or functionalising epoxide is selected from an aqueous solution, a liquid swelling agent, or an alcohol or mixture thereof. In some embodiments, the solution comprising the polyamine or copolymer thereof, cross-linking agent and/or functionalising epoxide is selected from any suitable solvent that can dissolve the reaction components. The solution comprising the polyamine or copolymer thereof may be the same as or different to the solution comprising the cross-linking agent and functionalising epoxide. The solution comprising the polyamine or copolymer and functionalising epoxide may be the same as or different to the solution comprising the cross-linking agent. The solution comprising the polyamine or copolymer and cross-linking agent may be the same as or different to the solution comprising the functionalising epoxide.

The solution comprising comprising the polyamine or copolymer thereof, cross-linking agent and/or functionalising epoxide may be an alcohol, for example methanol, ethanol, butanol, or isopropanol.

### Functionalising Epoxide

The functionalising epoxide can be the source of the optionally substituted alkanol group on the one or more amines of the cross-linked polyamine or copolymer thereof, for example via amine-epoxy addition which is provided below in Scheme 1 by way of example:

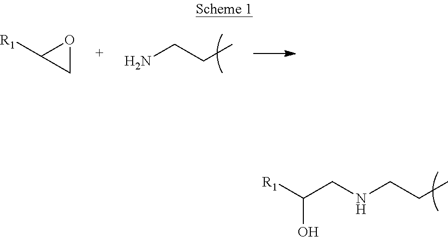

In one embodiment, the functionalising epoxide is a monoepoxide (i.e. comprises only one epoxide group). In one embodiment, the functionalising epoxide and cross-linking agents are different compounds.

In one embodiment, the functionalising epoxide has a structure of Formula II:

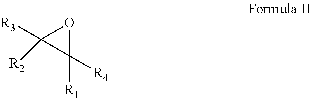

wherein R₁ to R₄ are defined herein

In one embodiment, the functionalising epoxide has a structure of Formula IIa:

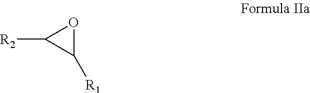

wherein R₁ and R₂ are defined herein.

In one embodiment, the functionalising epoxide has a structure of Formula IIb:

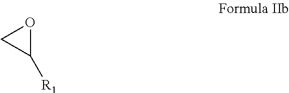

wherein R₁ is defined herein.

In one embodiment, the functionalising epoxide is selected from the group consisting of 1,2-epoxyethane (ethylene oxide), 1,2-epoxypropane (1,2-propylene oxide), 1,2-epoxybutane (1,2-butylene oxide), 1,2-epoxypentane (1,2-pentene oxide), 1,2-epoxyhexane (1,2-hexene oxide), and 1,2-epoxyoctane (1,2-octene oxide), decene oxide (1-decene oxide), dodecene oxide (1-dodecene oxide), tetradecene oxide (1-tetradecene oxide), hexadecene oxide (1-hexadecene oxide), octadecene oxide (1-octadecene oxide), Glycidol, (glycidoloxypropyl), butadiene monoxide, 1,2-epoxide-7-octene (1,2-epoxy-7-octene), isopropyl glycidyl ether, butyl glycidyl ether, t-butyl glycidyl ether, 2-ethylhexyl glycidyl ether, allyl glycidyl ether, cyclopentene oxide, cyclohexene oxide, cyclooctene oxide, cyclododecene oxide, 2,3-epoxide norbornene (2,3-epoxynorbornane), limonene oxide, 2,3-epoxy propylbenzene, styrene oxide, phenyl propylene oxide, 1,2-epoxy-3-phenoxy propane, benzyloxy methyl oxirane, glycy In the group consisting of glycidyl-methylphenyl ether, epoxypropyl methoxyphenyl ether, biphenyl glycidyl ether, and naphthyl glycidyl ether.

In one embodiment, the functionalising epoxide is a C₁₋₂₀alkylene oxide, for example 1,2-epoxyethane (ethylene oxide), 1,2-epoxypropane (1,2-propylene oxide), 1,2-epoxybutane (1,2-butylene oxide), 1,2-epoxypentane (1,2-pentene oxide), 1,2-epoxyhexane (1,2-hexene oxide), and 1,2-epoxyoctane (1,2-octene oxide), decene oxide (1-decene oxide), dodecene oxide (1-dodecene oxide), tetradecene oxide (1-tetradecene oxide), hexadecene oxide (1-hexadecene oxide), octadecene oxide (1-octadecene oxide). In one embodiment, the functionalising epoxide is 1,2-epoxybutane. However, it will be appreciated that provided the functionalising epoxide comprises a suitable epoxide group capable of functionalising an amine group (e.g. primary amine group) via epoxide-amine addition, any suitable functionalising epoxide can be used.

In some embodiments, the functionalising epoxide reacts with one or more primary (1º) amine groups of the polyamine or copolymer thereof to form a secondary (2º) amine group substituted with an optionally substituted alkanol group. It will be appreciated that the number of primary (1º) amine groups present in the polyamine or copolymer thereof can decrease following functionalising by the epoxide. In some embodiments, the functionalising epoxide can react with one or more secondary (2º) amine groups of the polyamine or copolymer thereof to form a tertiary (3º) amine group substituted with an optionally substituted alkanol group. In some embodiments, the process preferentially comprises epoxide-amine addition at one or more primary (1º) amine groups.

### Gaseous Streams and Atmospheres

The hydrogels of the present disclosure can remove an acidic gas from a gaseous stream or atmosphere containing the acidic gas.

The “acidic gas” may be carbon dioxide (CO₂) or hydrogen sulfide (H₂S) or a mixture thereof. In one specific embodiment, the acidic gas is CO₂. The acidic gas may be a component of a natural gas, such as acid gas, which is understood to be a natural gas mixture that contains significant quantities of acidic gases, namely, hydrogen sulfide H₂S CO₂. The acid gas may be sour gas, which is a specific type of acid gas that contains a significant amount of H₂S. In one embodiment, the acidic gas may be a contaminant in a hydrocarbon gas. Although the term ‘hydrocarbon gas’ general refers to natural gas, it will be appreciated by those skilled in the art that the term may equally apply to coal seam gas, associated gas, nonconventional gas, landfill gas, biogas, and flue gas. Alternatively, the acidic gas may be a component of lower acidic gas concentration gaseous streams or atmospheres, such as ambient air.

The acidic gas (e.g. CO₂ or H₂S) may be removed from the gaseous stream or atmosphere by being absorbed into the hydrogel. For example, the acidic gas may be absorbed into the hydrogel by a chemical and/or physical process. For example, the cross-linked polyamine or copolymer thereof comprises reactive amine groups capable of binding to the acidic gas. Additionally, the hydrogel may also comprise a liquid swelling agent, wherein the liquid swelling agent absorbs the acidic gas.

The gaseous stream or atmosphere may be any stream or atmosphere in which separation of one or more acidic gases from stream or atmosphere is desired. Examples of streams or atmospheres include product gas streams e.g. from coal gasification plants, reformers, precombustion gas streams, post-combustion gas streams (including in-line post combustion gas streams) such as flue gases, the exhaust streams from fossil-fuel burning power plants, sour natural gas, post-combustion, emissions from incinerators, industrial gas streams, exhaust gas from vehicles, exhaust gas from sealed environments such as submarines and the like.

In some embodiments, the gaseous stream or atmosphere may have an acidic gas concentration of less than about 200,000 parts per million (ppm). In one embodiment, the gaseous stream or atmosphere may have an acidic gas concentration of less than 150,000, 100,000, 75,000, 50,000, 25,000, 10,000, 5,000, 4,000, 1,000, 900, 800, 700, 600, 500, 400, 300, 200 or 100 ppm, for example less than about 10,000 ppm, or less than about 4,000 ppm, or less than about 1,000 ppm. In another embodiment, the gaseous stream or atmosphere may have an acidic gas concentration of between about 100 ppm to 100,000 ppm, about 100 ppm to about 10,000 ppm, or about 100 ppm to about 5,000 ppm.

It will be understood that 1 ppm equates to 0.0001 vol. %. For example, a gaseous stream or atmosphere having an acidic gas concentration of less than about 100,000 ppm equates to 10.0 vol. % of acidic gas in the gaseous stream.

### Low CO₂ Concentration Gaseous Streams or Atmospheres

The hydrogels of the present disclosure can remove CO₂ from low CO₂ concentration gaseous streams or atmospheres. For example, the process can remove CO₂ from a low CO₂ concentration gaseous stream or atmosphere. Examples of low concentration gaseous streams or atmospheres include the atmosphere (e.g. ambient air), ventilated air (e.g. air conditioning units and building ventilation), and partly closed systems which recycle breathing air (e.g. submarines or rebreathers). In some embodiments, the low CO₂ concentration gaseous stream or atmosphere may have a CO₂ concentration of less than about 200,000 parts per million (ppm). In one embodiment, the low CO₂ concentration gaseous stream or atmosphere may have a CO₂ concentration of less than 150,000, 100,000, 75,000, 50,000, 25,000, 10,000, 5,000, 4,000, 1,000, 900, 800, 700, 600, 500, 400, 300, 200 or 100 ppm. In another embodiment, the low CO₂ concentration gaseous stream or atmosphere may have a CO₂ concentration of between about 100 ppm to 100,000 ppm, about 100 ppm to about 10,000 ppm, about 100 ppm to about 5,000 ppm, about 100 ppm to about 1,000 ppm or about 100 ppm to about 500 ppm. In one embodiment, the low CO₂ concentration gaseous stream or atmosphere may have a CO₂ concentration of between about 200 ppm to about 500 pm, such as about 400 to 450 ppm.

In some embodiments, the low CO₂ concentration gaseous stream or atmosphere may have a CO₂ concentration of less than about 20, 15, 10, 7.5, 5, 2.5, 1, 0.5, 0.1, 0.09, 0.08, 0.07, 0.06, 0.05, 0.04, 0.03, 0.02 or 0.01 vol. %. In another embodiment, the low CO₂ concentration gaseous stream or atmosphere may have a CO₂ concentration of between about 0.01 vol. % to about 10 vol. %, about 0.01 vol. % to about 1 vol. %, about 0.01 vol. % to about 0.1 vol. %, or 0.01 vol. % to about 0.05 vol. %. In one embodiment, the low CO₂ concentration gaseous stream or atmosphere may have a CO₂ concentration of between about 0.02 vol. % to about 0.05 vol. %, such as about 0.04 vol. %.

In one embodiment, the low CO₂ concentration gaseous stream or atmosphere may have a CO₂ concentration the same as in ambient air (e.g. the atmosphere). Thus in one embodiment, the low CO₂ concentration gaseous stream or atmosphere may have a CO₂ concentration of about 400 ppm to 450 ppm CO₂, for example about 400 ppm to 415 ppm as in ambient air in most locations around the world. Accordingly, in one embodiment, the process is for direct air capture (DAC).

In one embodiment or example, the process is for direct air capture in indoor sealed environments (DACi). Thus, the CO₂ concentration gaseous stream or atmosphere may have a CO₂ concentration of up to 2,000 ppm.

In one embodiment or example, the process is for direct air capture in external power plants (DACex). Thus, the CO₂ concentration gaseous stream or atmosphere may have a CO₂ concentration of about 3,000 ppm to about 150,000 ppm.

In one embodiment or example, the gaseous stream or atmosphere may comprise less than 100 ppm (i.e. 0.01 vol. %) hydrocarbon gas. In one embodiment, the gaseous stream or atmosphere may comprise less 10, 8, 5, 2, 1, 0.5, 0.1 or 0.01 vol. % hydrocarbon gas. In one embodiment, the gaseous stream or atmosphere may comprise less than 100 ppm (i.e. 0.01 vol. %) hydrocarbon gas. For example, the gaseous stream or atmosphere may comprise less than about 100, 75, 50, 25, 20, 15, 10, 5, 4, 3, or 2 ppm hydrocarbon gas. The term ‘hydrocarbon gas’ will be understood to refer to a gaseous mixture of hydrocarbon compounds including, but not limited to methane, ethane, ethylene, propane, and other C₃₊ hydrocarbons. For example, it will be understood by a person skilled in the art that ambient air comprises methane as a minor impurity (e.g. 2 ppm/0.0002 vol. %), and that ambient air therefore may comprise less than 3 ppm hydrocarbon gas. The low CO₂ concentration gaseous stream or atmosphere may comprise predominantly of nitrogen makes up the major vol. % proportion in the gaseous stream. For example, the low CO₂ concentration gaseous stream or atmosphere may comprise at least about 50 vol. % nitrogen, for example at least about 70 vol. % nitrogen. In one embodiment, the low CO₂ concentration gaseous stream comprises about 78 vol. % nitrogen (e.g. ambient air).

The low CO₂ concentration gaseous stream or atmosphere may comprise an amount of water (e.g. the gaseous stream is damp/moist for example a humid gaseous stream). For example, the low CO₂ concentration gaseous stream or atmosphere may comprise between about 1 vol. % to about 10 vol. % water. Alternatively, the low CO₂ concentration gaseous stream or atmosphere may be a dry gaseous stream.

In an alternate embodiment, the process can capture CO₂ from a high CO₂ concentration gaseous stream or atmosphere. For example, the high CO₂ concentration gaseous stream or atmosphere may have a CO₂ concentration of 925 mbar (100 vol. %).

In some embodiments, the gaseous stream or atmosphere originates from a ventilation system, for example building ventilation or air conditioning. In other embodiments, the gaseous stream or atmosphere originates from a closed, or at least partially closed system, designed to recycle breathing gas, for example in a submarine, space craft, or aircraft. It will be appreciated that the hydrogels of the present disclosure can also absorb CO₂ from gaseous streams or atmospheres with higher CO₂ concentrations, highlighting the versatility of the hydrogels for a wide range of air capture applications. In an example, it is the ability of the hydrogels to capture CO₂ at relatively low concentrations (e.g. 400 ppm) which the present inventors found particularly surprising.

The low CO₂ concentration gaseous stream or atmosphere is contacted with the hydrogel. The gaseous stream or atmosphere may have a suitable flow rate to contact (e.g. pass through) the hydrogel. Alternatively, the gaseous stream or atmosphere may come into contact with the hydrogel without any back pressure or flow rate being applied (e.g. the gaseous stream may organically diffuse into the hydrogel upon contact). In some embodiments, the gaseous stream or atmosphere may be an atmosphere surrounding the hydrogel, for example a low CO₂ concentration atmosphere. In some embodiments, the gaseous stream or atmosphere passes through the hydrogel (e.g. enters from a first side or face on the hydrogel and exits from different side or face) or it may simply diffuse into the hydrogel, for example when the hydrogel is placed in an atmosphere, such as ambient air. As such, it will be understood that in some embodiments the gaseous stream does not need to be applied with a back pressure to essentially force the gaseous stream “through” the hydrogel, although in some embodiments this may be desirable, such as when the hydrogel is configured to a building ventilation system, for example. In one embodiment, the gaseous stream (e.g. atmosphere) diffuses into the hydrogel upon contact with the hydrogel.

In some embodiments, the gaseous stream or atmosphere has no flow rate, e.g. 0 m³/hour. In some embodiments, or examples, the gaseous stream has a flow rate of between about 0.01 m³/hr to about 50,000 m³/hr. The flow rate may be at least 0.01, 0.05, 0.1, 0.5, 1, 5, 10, 20, 30, 40, 50, 60, 70, 80, 90, 100, 200, 300, 400, 500, 600, 700, 800, 900 1,000, 2,000, 3,000, 4,000, 5,000, 6,000, 7,000, 8,000, 9,000, 10,000, 15,000, 17,000, 20,000, 30,000, 40,000, or 50,000 cubic metres per hour (m³/hr). In some embodiments, the gaseous stream has a flow rate of less than 50,000, 40,000, 30,000, 20,000, 17,000, 15,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 5, 1, 0.5, 0.1, 0.05, or 0.01 m³/hr. Combinations of these flow rates are also possible, for example between about 0.01 m³/hour to about 1500 m³/hour, between about 5 m³/hour to about 1000 m³/hour, between about 10 m³/hour to about 500 m³/hour, between about m³/hour to about 200 m³/hour, between about 60 m³/hour to about 1000 m³/hour, between about 0.01 m³/hr to about 5,000 m³/hr, about 5,000 to about 40,000 m³/hr, about 7,000 m³/hr to about 30,000 m³/hr, or about 10,000 m³/hr to about 20,000 m³/hour.

In some embodiments, the gaseous stream or atmosphere has a higher flow rate. In some embodiments, the gaseous stream has a flow rate of at least 1, 5, 10, 20, 50, 100, 500, 1,000, 5,000, 7,000, 10,000, 15,000, 17,000, 20,000, 30,000, 40,000, or 50,000 cubic metres per hour (m³/hr). In some embodiments, the gaseous stream or atmosphere has a flow rate of less than 50,000, 40,000, 30,000, 20,000, 17,000, 15,000, 10,000, 7,000, 5,000, 1,000, 500, 100, 50, 20, 10, 5, or 1 m³/hr. Combinations of these flow rates are also possible, for example between about 5,000 m³/hr to about 40,000 m³/hr, about 7,000 m³/hr to about 30,000 m³/hr, or about 10,000 m³/hr to about 20,000 m³/hour. Other combinations with the lower flow rates described above are also possible, for example between about 100 cm^{3 /}min (0.006 m³/hr) to about 50,000 m³/hr or 100,000 cm^{3 /}min (6 m³/hr) to about 20,000 m³/hr.

In some embodiments, increasing the flow rate of the gaseous stream or atmosphere as it contacts the hydrogel leads to a faster rate of CO₂ absorption and capture in the hydrogel. For industrial scale applications, the flow rate of the gaseous stream may be up to 1000 m³/hour. In some embodiments, the gaseous stream has no flow rate (e.g. an ambient atmosphere).

The low CO₂ concentration gaseous stream or atmosphere may be at least partially dried to remove at least some of the moisture (H₂O) present in the gaseous stream prior to contacting with the hydrogel. For example, the gaseous stream may be dried to a humidity of less than 10%, 8%, 6%, 4%, or 2%, or to a humidity between any two of these values, for example between about 1% and about 10%, about 1% and about 5%, about 1% and about 3%. The gaseous stream or atmosphere may be dried by any conventional means (e.g. passing through a hygroscopic material or contacted with a source of heat) and its humidity measured via protocols as described herein.

In some embodiments, the low CO₂ concentration gaseous stream or atmosphere has an initial CO₂ concentration prior to contacting the hydrogel, and has a final CO₂ concentration after contacting the hydrogel (also referred to herein as an effluent gaseous stream and/or effluent CO₂ concentration). It will be appreciated that as CO₂ is absorbed into the hydrogel from the gaseous stream, the concentration of CO₂ in the effluent stream will be lower than the initial CO₂ concentration of the gaseous stream or atmosphere prior to contact (e.g. passing through) with the hydrogel.

The concentration of CO₂ in the gaseous stream or atmosphere can be measured by any suitable means, for example an isotopic analyser (e.g. using a G2201-i Isotopic Analyzer (PICARRO) and/or infrared spectrometer (e.g. an in-line calibrated cavity ring-down IR spectrometer). The concentration of CO₂ in the gaseous stream or atmosphere can be monitored by any suitable means, for example an SprintIR®-6S covering a range from 0-100% and K30 ambient sensor with a range of 0-1% CO₂.

### Adsorption Apparatus

In some embodiments, there is provided an adsorption apparatus for capturing an acidic gas from a gaseous stream or atmosphere containing the acidic gas, comprising: a chamber enclosing the hydrogel, as defined according to any one of the embodiments or examples described herein and/or prepared according to any one of the embodiments or examples described herein, the chamber comprising an inlet through which gaseous stream or atmosphere can flow to the hydrogel and an outlet through which the effluent gaseous stream can flow out from hydrogel. The hydrogel may be located between the inlet and outlet of the chamber.

In some embodiments or examples, the apparatus may comprise two or more chambers enclosing the hydrogel in each chamber connected in parallel to the gaseous stream. The apparatus may comprise at least three chambers enclosing the hydrogel in each chamber, wherein each chamber may be connected in parallel to the gaseous stream.

The hydrogel enclosed within the at least three chambers may be operated in different sections of the adsorption and regeneration cycle to produce a continuous flow of the effluent gaseous stream.

Fluid flow is typically required to move the gaseous stream from the inlet of the chamber, across the hydrogel enclosed and out of the chamber through the outlet. The fluid flow may be driven by at least one fluid flow device which drives a fluid flow from the inlet to the outlet of the adsorption apparatus. A variety of different fluid flow devices can be used. In some embodiments or examples, the fluid flow device comprises at least one fan or pump. In some embodiments, or examples, the flow rate of the gaseous stream entering through the inlet, across the hydrogel, may be between about 0.01 m³/hr to about 50,000 m³/hr. The flow rate may be at least 0.01, 0.05, 0.1, 0.5, 1, 5, 10, 20, 30, 40, 50, 60, 70, 80, 90, 100, 200, 300, 400, 500, 600, 700, 800, 900 1,000, 2,000, 3,000, 4,000, 5,000, 6,000, 7,000, 8,000, 9,000, 10,000, 15,000, 17,000, 20,000, 30,000, 40,000, or 50,000 cubic metres per hour (m³/hr). In some embodiments, the gaseous stream has a flow rate of less than 50,000, 40,000, 30,000, 20,000, 17,000, 15,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 5, 1, 0.5, 0.1, 0.05, or 0.01 m³/hr. Combinations of these flow rates are also possible, for example between about 0.01 m³/hr to about 5,000 m³/hr, about 5,000 to about 40,000 m³/hr, about 7,000 m³/hr to about 30,000 m³/hr, or about 10,000 m³/hr to about 20,000 m³/hour. The flow rate of the gaseous stream through the chamber and across the hydrogel may be achieved with substantially no back pressure measurable through or across the hydrogel. In an alternate embodiment or example, pressure variance or suction may be used to drive fluid flow of the gaseous stream through the device. For industrial scale applications, the flow rate of the gaseous stream may be up to 1000 m³/hour.

The chamber may have any suitable configuration. In some embodiments or examples, the chamber comprises an inlet at one end and an outlet at the opposite end. In an embodiment or example, a substrate, as described herein, can be located or otherwise packed within the chamber in a compacted manner to increase the surface area within that volume.

The apparatus may comprise a single or multiple chambers, wherein each chamber may enclose the hydrogel, as described herein. In some embodiments or examples, the apparatus may comprise two or more chambers enclosing a hydrogel in each chamber connected in parallel to the gaseous stream. In another embodiment or example, the apparatus may comprise at least three chambers enclosing the hydrogel in each chamber, wherein each chamber may be connected in parallel to the gaseous stream. In some embodiments or examples, the hydrogel enclosed within the at least three chambers may be operated in different sections of the adsorption and regeneration cycle to produce a continuous flow of the effluent gaseous stream.

In some embodiments or examples, the process may be a cyclical method, where the steps of adsorbing the acidic gas in the hydrogel enclosed by the chamber and releasing the acidic gas through operation of at least one desorption arrangement in a repetitive cycle so to continuously produce the effluent gaseous stream. The cycle time may depend on configuration of the adsorption apparatus, the configuration of the chamber(s), the type of desorption arrangement, the composition of the hydrogel, breakthrough point, saturation point and characteristics of the hydrogel, temperature, pressure and other process conditions. In some embodiments or examples, the cycle time may be about 10, 15, 20, 30, 45, 60 minutes (1 hour), 2, 5, 10, 24, 48 or 36 hours.

In some embodiments or examples, the desorption arrangement can take any number of forms depending on whether heat and/or reduced pressure is being used. In some embodiments or examples, the apparatus is designed for pressure swing adsorption, with desorption being achieved by reducing the pressure for example using a vacuum pump to evacuate the gas from around the chamber enclosing the hydrogel. In other embodiments or examples, temperature swing adsorption is undertaken to collect the acidic gas from the hydrogel. This can be achieved using direct heating methods.

In some embodiments or examples, the desorption arrangement may comprise a temperature swing adsorption arrangement where the hydrogel is heated. For example, operating at least one desorption arrangement heats the hydrogel to a temperature of between about 20 to 140 ° C.

The present disclosure provides a process where a gaseous stream containing a concentration of acidic gas is fed into adsorptive contact with the hydrogel, as described herein. After the hydrogel is charged with an amount of the acidic gas, the desorption arrangement is activated forcing at least a portion of the acidic gas to be released from the hydrogel. The desorbed hydrogel can be collected using a secondary process.

In other words, the effluent gaseous stream from the outlet can flow to a variety of secondary processes. For example, for carbon dioxide capture, the adsorption apparatus of the present disclosure can be integrated with a liquefier and/or dry ice pelletiser to provide dry ice on-demand. In another example, the adsorption apparatus of the present disclosure can be integrated with a hydrogenation apparatus to convert carbon dioxide (CO₂) to methane. In yet another example, the adsorption apparatus of the present disclosure may be used to adsorb carbon dioxide (CO₂) and store it for use at a different time. This would be applicable in a green-house type environment where CO₂ is adsorbed at a particular time and used at a different time. In yet another example, the adsorption apparatus of the present disclosure may be particularly applicable for CO₂ in a confined space. For example, inside a submarine, space craft, air craft or other confined space like a room where the adsorption apparatus would be used to remove CO₂, and the apparatus capable of adsorbing and desorbing CO₂ in a continuous cycle.

The adsorption apparatus of the present disclosure is advantageously compact and can be located much closer to end users, thereby allowing disruptive supply opportunities and better customer value.

### Processes for Acidic Gas Capture/Release and Regeneration of Hydrogel

The acidic gas (e.g. CO₂) may be removed from the gaseous stream by being absorbed into a hydrogel. In some embodiments, the hydrogel is capable of absorbing between about 10 mg of acidic gas per g of hydrogel (mg/g) to about 300 mg/g acidic gas. In some embodiments, the hydrogel is capable of absorbing at least about 10, 20, 30, 40, 50, 60, 70, 80, 90, 100, 120, 150, 200, 250 or 300 mg/g acidic gas. In other embodiments, the hydrogel is capable of absorbing less than about 300, 250, 200, 150, 120, 100, 90, 80, 70, 60, 50, 40, 30, 20 or 10 mg/g acidic gas. Combinations of these absorption values are possible, for example the hydrogel is capable of absorbing between about 10 mg/g to about 80 mg/g acidic gas, between about 20 mg/g to about 70 mg/g acidic gas, or between about 100 mg/g to about 300 mg/g, or between about 200 mg/g to about 300 mg/g.

In some embodiments, the hydrogel has a working capacity of between 1 mmol g⁻¹ and 5 mmol g⁻¹. In some embodiments, the hydrogel has a working capacity of at least about 1, 1.5, 2. 2.5, 3. 3.5, 4, 4.5, or 5 mmol g⁻¹. In some embodiments, the hydrogel has a working capacity of less than 5, 4.5, 4, 3.5, 3. 2.5, 2, 1.5 or 1 mmol g⁻¹. Combinations of these values to form one or more ranges are possible, for example between about 1 mmol g⁻¹ to 3 mmol g⁻¹. In some embodiments, the hydrogel has a working capacity of between about 1 to 3, 1.2 to 3, 1.5 to 3, or 2 to 3 mmol g⁻¹ to about 3 mmol g⁻¹ across at least about 10, 20, 50, 100, 150, 200, 250, 300, 350, 400, 450 500, 750, 1000, 10,000, 50,000, 75,000 or 100,000 absorption/regeneration cycles. The working capacity of a hydrogel is the overall gas absorption/desorption performance of the hydrogel.

A hydrogel that has a working capacity that remains substantially constant across numerous absorption/regeneration cycles (e.g. temperature swing absorption (TSA) cycles) demonstrates good cyclic stability and reduced degradation compared to hydrogels that have a decrease in working capacity across numerous cycles. In one embodiment, the hydrogel maintains a working capacity after two or more absorption/regeneration cycles of at least 80%, 95%, 90%, 90% or 95%, of the working capacity of the hydrogel following the first absorption/regeneration cycle. The hydrogel may maintain a working capacity after at least 10, 20, 50, 100, 150, 200, 250, 300, 350, 400, 450, 500, 750, 1000, 10,000, 50,000, 75,000 or 100,000 absorption/regeneration cycles of at least 80%, 95%, 90%, 90% or 95%, of the working capacity of the hydrogel following the first absorption/regeneration cycle. The cycle time may be at least 1, 2, 5, 10, 15, 20, 30, 60, 90 or 120 minutes, for example 30 minutes. Combinations of the number of cycles, cycle times and working capacity % are also possible.

In some embodiments, the hydrogel is capable of absorbing between about 1% to about 20% wt. acidic gas. In some embodiments, the hydrogel is capable of absorbing at least about 1, 2, 3, 4, 5, 7, 10, 12, 14, 16, 18 or 20% wt. acidic gas. In some embodiments, the hydrogel is capable of absorbing less than about 20, 18, 16, 14, 12, 10, 7, 5, 4, 3, 2 or 1% wt. acidic gas. Combinations of these absorption values are possible, for example between about 1% to 10% wt. acidic gas. The present inventors have surprisingly identified that the alkanol functionalised hydrogels of the present disclosure can absorb a higher % wt. of acidic gas compared to hydrogels not functionalised with an alkanol. This is surprising particularly as the number of reactive amine sites decrease as a result of functionalisation (e.g. conversion of primary amines to secondary amines, and secondary amines to tertiary amines).

In some embodiments, the hydrogel removes at least about 10% of acidic gas is removed from the gaseous stream or atmosphere (e.g. at least about 10% of CO₂ is absorbed into the hydrogel from the gaseous stream or atmosphere). In some embodiments, at least about 10%, 25%, 50%, 75%, 90%, or 95% of acidic gas is removed from the gaseous stream or atmosphere. According to some embodiments or examples, a lower % of acidic gas removal from the gaseous stream or atmosphere provides further advantages, where at a maximum flow rate, the hydrogel saturates quicker even though a small % of acidic gas is absorbed from the gaseous stream or atmosphere. This allows for quick cycling and coupled with the good regeneration and stability properties of the hydrogel, can allows for an increase in overall acidic gas uptake per day. This can be achieved by using very high gas flow rates without a back pressure across the hydrogel, and while a low outlet gas % concentration is measured, saturation is quickly achieved.

In some embodiments, the gaseous stream has a lower flow rate of at least about 100, 1,000, 10,000, 25,000, 50,000, 75,000, 100,000, or 200,000 sccm. In some embodiments, the gaseous stream has a higher flow rate of at least 1, 5, 10, 20, 50, 100, 500, 1,000, 5,000, 7,000, 10,000, 15,000, 17,000, 20,000, 30,000, 40,000, or 50,000 cubic metres per hour (m³/hr). At these flow rates, in some embodiments at least about 10% of acidic gas is removed from the gaseous stream or atmosphere.

The gaseous stream contacts the hydrogel (e.g. passes through a bed comprising the hydrogel) resulting in an effluent gaseous stream following contact with the hydrogel. As described above, before contact with the hydrogel, the gaseous stream has an initial acidic gas concentration. After contact with the hydrogel, the effluent gaseous stream has an effluent acidic gas concentration. The concentration of acidic gas in the effluent gaseous stream following contact with the hydrogel may be measured to determine the concentration of acidic gas remaining in the gaseous stream.

In some embodiments, over time, the concentration of acidic gas in the effluent gaseous stream following contact with the hydrogel may increase indicating reduced or no more acidic gas absorption is taking placed upon contact of the gaseous stream with the hydrogel (e.g. indicating the hydrogel is “saturated” (e.g. spent) and little to no more acidic gas absorption is occurring). This can act as an indicator to replace and/or regenerate the hydrogel to continue acidic gas capture. The concentration of acidic gas in the effluent gaseous stream may be measured by any suitable means, for example using an in-line calibrated cavity ring-down IR spectrometer.

In some embodiments, the hydrogel may be enclosed in a suitable chamber, wherein the chamber comprises one or more inlets through which the gaseous stream can flow to contact the hydrogel enclosed therein, and one or more outlets through which the effluent stream can flow out from the chamber. Alternatively, the hydrogel may be enclosed in a suitable chamber comprising one or more openings through which the gaseous stream can diffuse through (e.g. absent a back pressure/flow rate) to contact the hydrogel enclosed therein. It will be appreciated that the chamber can take a number of forms provided the gaseous stream can access the hydrogel. In one embodiment, the chamber may be a packed-bed column as described herein.

In some embodiments, the hydrogel may be provided as a bed, wherein the contacting the gaseous stream with the hydrogel comprises passing the gaseous stream through the bed comprising the hydrogel. In one embodiment, the hydrogel is provided as a packed-bed reactor. In other embodiments, the contacting the gaseous stream with the hydrogel comprises introducing a flow of the hydrogel into the gaseous stream, for example using a fluidised bed reactor.

The hydrogel may be contacted with the gaseous stream for any suitable period of time, for example until the hydrogel is spent and no more acidic gas absorption is occurring. In one embodiment, the hydrogel is in contact with the gaseous stream until the concentration of acidic gas in the effluent gaseous stream is the same as the initial concentration of acidic gas of the gaseous stream. In some embodiments, the hydrogel is in contact with the gases stream for at least about 5, 10, 30, 60 seconds (1 minute), 10, 15, 20, 30, 45, 60 minutes (1 hour), 2, 5, 10, 24, 48 or 36 hours.

In some embodiments, the hydrogel provides various rates of acidic gas absorption. In one embodiment, the rate of acidic gas absorption can be measured by monitoring the acidic gas concentration of the effluent gaseous stream over time. For example, the concentration of acidic gas in the effluent gaseous stream may be less than about 50% of the initial acidic gas concentration after about 20 minutes of contact with the hydrogel. In some examples, the concentration of acidic gas in the effluent gaseous stream may be less than about 5% of the initial acidic gas concentration after about 100 seconds of contact with the hydrogel (in other words at least about 95% of acidic gas is removed from the gaseous stream after 100 seconds). Other rates of acidic gas absorption are also possible.

The acidic gas after absorption in the hydrogel can be released by breaking the bonds between the acidic gas and the amine groups (e.g. the bond between the CO₂ and amine). This can be achieved through using temperature (through heating) or pressure (through vacuum). This may involve heating the column containing the hydrogel or passing through a hot gas stream (e.g. steam) or hot air. Such desorption may be provided by any suitable environment capable of providing a heated environment (e.g. temperature) or a pressurised environment (e.g. through vacuum), or a combination thereof, in contact with or surrounding the hydrogel which can desorb at least some of the acidic gas absorbed within the hydrogel. Such desorption environment can operate in an “on” or “off” state. For example, once the concentration of acidic gas in the effluent gaseous stream following contact with the hydrogel has increased to a level indicating reduced or no more acidic gas absorption is taking place, the desorption environment may be switched “on” to desorb acidic gas from the hydrogel.

In some embodiments, at least 70%, 80%, 85%, 90%, 95%, 97%, 98% or 99% of the absorbed acidic gas is desorbed from the hydrogel.

In some embodiments, the hydrogel maintains an acidic gas absorption after ageing for 21 days at 60° C., 80 mbar and 10 sccm air flow of at least 80%, 95%, 90%, 90% or 95%, of the initial acidic gas absorption of the hydrogel before ageing. Ageing as used herein refers to the exposure of the hydrogel to numerous absorption and desorption cycles.

The processes as disclosed herein may be conducted at ambient temperatures, for example ranging from about 10 to 35° C. The processes may also be conducted generally around typical atmospheric pressures (e.g. between about 90 and 105 kPa, and more typically about 101 kPa). For example, ambient temperature may be between 15 and 30° C., or 20 to 25° C.

The processes using the hydrogels as described herein are also suitable for use in environments with low or high humidity. Low humidity in this instance means partial water vapor pressures of less than about 5 mb. At about 21° C., this corresponds to a relative humidity of around 20% or less. High humidity in this instance means partial water vapor pressures of more than about 5 mb. At about 21° C., this corresponds to a relative humidity of greater than about 20%. Relative humidity is defined as follows.

$$Relative Humidity = \frac{Actual vapor pressure}{Saturated vapor pressure} \times 100 \%$$

Saturated vapor pressures for water are well known and change depending on the temperature (Donald Ahrens, 1994, Meteorology Today—an introduction to weather, climate and the environment Fifth Edition—West Publishing Co). As a consequence, the water vapor pressure will change with temperature for a given relative humidity. An illustration of this is provided below (http ://ww2010. atmos.uiuc. edu/%28Gh%29/guides/mtr/cld/dvlp/rh.rxml, downloaded December 2014).

| | 20% Relative | 80% Relative | 100% Relative |
|---|---|---|---|
| | Humidity Partial | Humidity Partial | Humidity Saturated |
| Temperature | Water Vapor | Water Vapor | Water Vapor |
| (° C.) | Pressure (mb) | Pressure (mb) | Pressure (mb) |
| 10 | 2.5 | 9.8 | 12.3 |
| 15 | 3.4 | 13.6 | 17.1 |
| 20 | 4.7 | 18.7 | 23.4 |
| 25 | 6.3 | 25.4 | 31.7 |
| 30 | 8.5 | 34.0 | 42.5 |
| 35 | 11.3 | 45.0 | 56.3 |

While the process is effective for use in environments with low humidity, it is also effective at a higher humidity where other treatments may not be effective. In other words, one of the advantages of the present process and hydrogels are that they can be used across a relatively broad application window (e.g. combination of broad parameters of temperature, pressure and humidity), and in particular across a broad humidity range, even though a further particular advantage is its use at higher humidity.

The process may, for example, be performed at a relative humidity of less than about 90%, 80%, 70%, 60%, 50%, 40%, 30%, 20%, 18%, 16%, 14%, 12%, 10%, 8%, 6%, 4%, or 2%. The process may be performed at a relative humidity of greater than about 1%, 2%, 4%, 6%, 8%, 10%, 12%, 14%, 16%, 18%, 20%, 30%, 40%, 50%, 60%, or 70%. The process may be performed at a relative humidity of between any two of these upper and/or lower values, for example between about 1% and about 90%, about 2% and about 50%, about 10% and about 70%, about 2% and about 30%, about 1% and about 20%, or about 4% and about 18%. It will be appreciated that the relative humidity for a given partial water vapor pressure depends on temperature. The partial water vapor pressure and temperature are independent variables and relative humidity (RH) is a dependent variable although there is a constraint that the relative humidity cannot exceed 100% at any particular temperature. For example, any one or more of the above relative humidity values may be provided where the temperature is between about 10 to 45° C., between about 15 and 40° C., or between about 20 to 35° C. The above relative humidity values may for example be where the temperature is at value of about 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C. 36° C., 37° C. 38° C. 39° C. 40° C. 41° C., 42° C., 43° C., 44° C., or 45° C. The application window for the process as presently disclosed may be any combination of the above RH and temperature ranges or values. For example, the application window may be where the RH is between about 1% and about 70% and a temperature range between about 15° C. and about 40° C.

The humidity may be provided by a partial water vapour pressure (in mb) of less than about 60, 50, 40, 30, 20, 15, 14, 13, 12, 11, 10, 9, 8, 7, 6, 5, 4, 3, or 2. The humidity may be provided by a partial water vapour pressure (in mb) of more than about 1, 2, 3, 4, 5, 6, 7, 8, 9, 10, 11, 12, 13, 14, 15, 20, 30, 40, 50, 60. The humidity may be provided by a partial water vapour pressure (in mb) in a range of between any two of these values, for example between about 1 and about 50, such as about 2 and about 25, such about 3 and about 15, such as about 4 and about 10. The humidity may be provided by a given temperature according to a temperature value or range as described above, although it will be appreciated that the temperature values are such that the humidity does not exceed 100% relative humidity or its partial vapour pressure does not exceed its saturated vapour pressure. The relative humidity at a given temperature for any of these partial water vapour pressure values may for example be less than about 90%, 80%, 70%, 60%, 50%, 40%, 30%, or 20%.

### EXAMPLES

In order that the disclosure may be more clearly understood, particular embodiments of the invention are described in further detail below by reference to the following non-limiting experimental materials, methodologies and examples.

### General Materials

All chemicals are purchased from commercial sources and are used as supplied. Branched PEI (Mw˜800), branched PEI (Mw˜25,000) PEI solution (Mw˜750,000, 50 wt. % in H₂O), diethanolamine (DEA), triglycidyl trimethylolpropane ether (TMPTGE or TTE, cross-linker), PEG, amino acid salt, tetraethylpentamine (TEPA), 1,2-epoxybutane (i.e. 1,2-butylene oxide) (BO), sodium phosphate, and ethanol were supplied by Sigma-Aldrich. Branched PEI (Mw˜1,800) and branched PEI (Mw 10,000) were obtained from Alfa Aesar. Distilled water was used in the preparation of PEI solutions. Ambient air was used for the direct air capture studies.

### Example 1: Fabrication of Functionalised Hydrogels

To prepare the functionalised hydrogel, the proportion of primary amines in the branched polyethylenimine (PEI) was estimated based on literature values of similar polymers that were determined using ¹H or ¹³C NMR, with an average primary:secondary:tertiary amine ratio of about 36:37:27. Based on this ratio, the number of moles of 1,2-epoxybutane required to react the remaining primary amines after crosslinking with trimethylolpropane triglycidyl ether was calculated. For a 5:1 weight ratio of PEI to crosslinker (20% of the PEI's weight in crosslinker), assuming the PEI consisted of 0.25 moles primary amine/mole of PEI then 27.5% of the PEI's weight in 1,2-epoxybutane was used.

The PEI was dissolved in a beaker in twice its weight in ethanol. In a separate beaker the crosslinker and butylene oxide were combined and dissolved in twice their weight in ethanol. The two solutions were then combined, stirred vigorously and left to functionalise/crosslink overnight. After the PEI functionalization with 1,2-epoxybutane, the ratio of primary amine gradually decreased, while the secondary and tertiary amines increased. The material was then dried at 80 degree C. overnight to remove ethanol and was subsequently swollen in 100% DEA solution.

It will be appreciated that the proportion of primary amines can also be readily evaluated for other polyamines, including for example other polyalkylenimines such as polyethylenimine, polypropylenimine, and polyallylamine, and hydrogels may be subsequently formed following a similar protocol.

### Example 2: Acidic Gas Capture Using Functionalised Hydrogels

The functionalised hydrogels demonstrated a higher uptake compared to the hydrogels that were not functionalized by 1,2-epoxybutane, giving an absorption of 7.3% vs 3.9% for the unfunctionalized PEI under the same conditions and same non aqueous solvent ratio (capturing CO₂ from air).

### Example 3: Effect of Liquid Swelling Agent on Acidic Gas Capture

The effect different liquid swelling agents had on acidic gas capture was investigated using the functionalised hydrogels, which are outlined in Table 1.

The labels for the hydrogel are based on the number of moles of trimethalolpropane triglycidyl ether cross linking agent (CL) and butylene oxide functionalising epoxide (BO) compared to the moles of PEI (polyethylenimine) used. For example, PEI-CL-0.028-B0-0.17 therefore means a ratio of 0.17 moles of butylene oxide and 0.028 moles of trimethalolpropane triglycidyl ether for every mole of PEI used. All CO2 uptake values are based on the total weight of the hydrogel including the PEI and any liquid swelling agent (including chelators or amino acid salts added). Bulk synthesis as a suffix describes a polymer made in substantial quantities (e.g. >25g) as opposed to the initial testing quantities (approximately 15g). The suffix PO₄ denotes sodium phosphate as a chelator was added (5% of PEI weight) to improve stability. All runs were for capture of CO₂ from air (direct air capture, DAC) performed with dry industrial grade air (400-500 ppm CO₂) from a G size cylinder unless otherwise stated.

TABLE 1

| | | | CO₂ |
|---|---|---|---|
| | | Ratio of solvent | uptake |
| | Hydrogel | to PEI | (wt %) |
| 1 | PEI-CL-0.028 (no | 2 to 1 DEA | 3.9% |
| | functionalisation) | | |
| 2 | PEI-CL-0.028-BO-0.13 | 2 to 1 DEA | 6.84 |
| 3 | PEI-CL-0.028-BO-0.15 | 2 to 1 DEA | 6.69 |
| 4 | PEI-CL-0.028-BO-0.17 | 2 to 1 DEA | 7.05 |
| 5 | PEI-CL-0.028-BO-0.22 | 2 to 1 DEA | 5.49 |
| 6 | PEI-CL-0.028-BO-0.17- Bulk | 2 to 1 DEA | 7.86 |
| | synthesis | | |
| 7 | PEI-CL-0.028-BO-0.17- Bulk | 2 to 1 PEG | 1.48 |
| | synthesis | | |
| 8 | PEI-CL-0.028-BO-0.17- Bulk | 2 to 1 PEG - humidified | 2.06 |
| | synthesis | air | |
| 9 | PEI-CL-0.028-BO-0.17- Bulk | 2 to 1 20% amino acid | 1.10 |
| | synthesis | salt in PEG | |
| 10 | PEI-CL-0.028-BO-0.17- Bulk | 2 to 1 DEA | 7.6 |
| | synthesis-PO4 | | |
| 11 | PEI-CL-0.028-BO-0.17- Bulk | 2 to 1 PEG | 1.31 |
| | synthesis-PO4 | | |
| 12 | PEI-CL-0.028-BO-0.17- Bulk | 2 to 1 10% amino acid | 1.87 |
| | synthesis-PO4 | salt in PEG | |
| 13 | PEI-CL-0.028-BO-0.17- Bulk | 2 to 1 5% amino acid | 2.07 |
| | synthesis-PO4 | salt in PEG | |
| 14 | PEI-CL-0.028-BO-0.17- Bulk | 1.5 to 1 10% amino acid | 1.70 |
| | synthesis-PO4 | salt in PEG | |
| 15 | PEI-CL-0.028-BO-0.17- Bulk | 2 to 1 30% alkylamine | 2.21 |
| | synthesis-PO4 | in PEG | |
| 16 | PEI-CL-0.028-BO-0.17- Bulk | 1.5 to 1 30% alkylamine | 2.92 |
| | synthesis-PO4 | in PEG | |
| 17 | PEI-CL-0.028-BO-0.17- Bulk | 1.5 to 1 10% alkylamine | 2.34 |
| | synthesis-PO4 | in PEG | |

### Example 4: Ageing Test

This test was designed to simulate 500+ cycles for using hydrogel 14 in table 1, by exposing the hydrogel to 21 days at 60° C. under vacuum (80mbar) and 10 sccm air flow. The hydrogel stability was assessed by comparing the initial CO₂ uptake (1.7%) to after ageing (1.4%) (see FIG. 6). 21 days under these conditions simulates >500+ cycles based on the regeneration time for the material. Visually the hydrogel showed little sign of ageing (minor discolouration of the polymer).

There was a small mass loss (went from 3.56 to 3.34 g, loss of 6%) which can be attributed to loss of trace amounts of water from the liquid swelling agent (PEG). result was equivalent to 500 cycles so the material is stable at 60° C. for an economically useful amount of cycles.

### Example 5: Regeneration of Functionalised Hydrogels

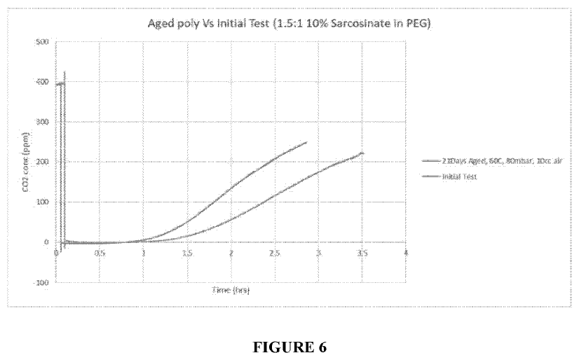

During regeneration under conditions relevant to large scale deployment the hydrogel will be exposed to CO₂ as it is released from the material. Under a CO₂-rich atmosphere there is typically a significant deactivation of amines via urea formation (that is, dehydrative condensation between amines and CO₂). The CO₂ uptake of the functionalised hydrogels after 30 days of operation across a number of cycles did not decrease (see FIG. 5). This demonstrates the excellent stability of the functionalised hydrogels. In particular, 1.5kg of functionalised hydrogels were exposed to air at a rate of 70 L/min over (total volume of air is 1,008,000 litres) with no oxidation. During this experiment the functionalised hydrogels were also heated to 120° C. for 120 hours in the presence of CO₂ which is ideal conditions for degradation through mechanisms such as urea formation, but no loss in performance was observed because there were minimal primary amines present in the cross-linked polyamine due to the epoxide functionalisation described herein.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

The present application claims priority from AU2021900632 filed on 5 Mar. 2021, the entire contents of which are incorporated herein by reference.

1. A self-supported hydrogel particulate for capture of acidic gas from a gaseous stream or atmosphere, the hydrogel particulate comprising a cross-linked polyamine or copolymer thereof,
wherein the cross-linked polyamine comprises amine groups capable of binding to the acidic gas, wherein one or more amine groups are substituted with an optionally substituted alkanol group.

2. (canceled)

3. (canceled)

4. (canceled)

5 (canceled)

6. (canceled)

7. (canceled)

8. The hydrogel particulate of claim 1, wherein the optionally substituted alkanol group is an optionally substituted hydroxyethyl group.

9. The hydrogel particulate of claim 8, wherein the optionally substituted hydroxyethyl group has a structure of Formula I: 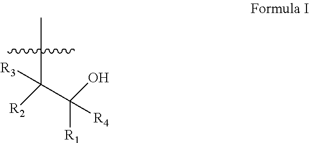
wherein:
R₁ to R₄ are each independently selected from hydrogen or an optionally substituted alkyl, alkenyl, alkynyl, alkoxy, cycloalkyl, aryl, heteroalkyl or heterocyclyl, or R₁ or R₄, together with R₂ or R₃, form an optionally substituted cycloalkyl, aryl or heterocyclyl; and [symbol]
represents an attachment point on the one or more amino groups of the cross-linked polyamine or copolymer thereof.

10. The hydrogel particulateof claim 9, wherein the optionally substituted hydroxyethyl group has a structure of Formula Ia: 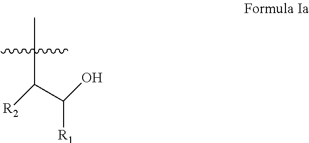
wherein:
R₁ and R₂ are each independently selected from hydrogen or an optionally substituted alkyl, alkenyl, alkynyl, alkoxy, cycloalkyl, aryl, heteroalkyl or heterocyclyl or R₁ and R₂ together form an optionally substituted cycloalkyl, aryl or heterocyclyl; and [symbol]
represents an attachment point on the one or more amino groups of the cross-linked polyamine or copolymer thereof.

11. The hydrogel particulate of claim 10, wherein R₁ and R₂ are each independently selected from hydrogen or an optionally substituted C₁₋₂₀alkyl, C₂₋₂₀alkenyl, C₂₋₂₀alkynyl, C₁₋₂₀alkoxy, C₃₋₂₀cycloalkyl, C₃₋₂₀aryl, C₁₋₂₀heteroalkyl or C₃₋₂₀heterocyclyl, or R₁ and R₂ together form an optionally substituted C₃₋₂₀cycloalkyl, C₃₋₂₀aryl or C₃₋₂₀heterocyclyl.

12. The hydrogel particulate of claim 8, wherein the optionally substituted hydroxyethyl group has a structure of Formula Ib or Formula Ic: 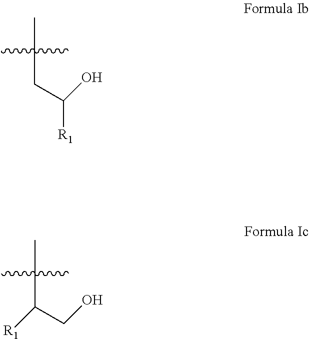
wherein:
R₁ is selected from hydrogen or an optionally substituted C₁₋₁₀alkyl, C₂₋₁₀alkenyl, C₂₋₁₀alkynyl, C₃₋₁₀cycloalkyl, C₃₋₁₀aryl, C₁₋₁₀heteroalkyl or C₃₋₁₀heterocyclyl; and [symbol]
represents an attachment point on the one or more amino groups of the cross-linked polyamine or copolymer thereof.

13. The hydrogel particulate of claim 1, wherein the optionally substituted alkanol group is a C₁₋₁₀alkylhydroxyl.

14. (canceled)

15. (canceled)

16. (canceled)

17. (canceled)

18. The hydrogel particulate of claim 1, wherein the polyamine or copolymer thereof comprises a polyalkylenimine.

19. The hydrogel particulate of claims 1, wherein the polyalkylenimine is selected from the group consisting of polyethylenimine (PEI), polypropylenimine, and polyallylamine, or a copolymer thereof.

20-36. (canceled)

37. The hydrogel particulate of claim 1, wherein the hydrogel comprises a liquid swelling agent absorbed within the hydrogel.

38. The hydrogel particulate of claim 37, wherein the hydrogel has a swelling capacity of between about 1 g/g to about 200 g/g of liquid swelling agent.

39. (canceled)

40. (canceled)

41. (canceled)

42. (canceled)

43. The hydrogel particulate of claim 37, wherein the liquid swelling agent is selected from the group consisting of water, alcohols, polyol compounds, glycols, alkanolamines, alkylamines, alkyloxyamines, piperidines, piperazines, pyridines, pyrrolidones, and combinations thereof.

44. (canceled)

45. (canceled)

46. (canceled)

47. (canceled)

48. (canceled)

49. (canceled)

50. A process for preparing a hydrogel particulate of claim 1, comprising,
mixing a solution comprising a polyamine or copolymer thereof, cross-linking agent and a ftmctionalising epoxide at a temperature and for a period of time effective to cross-link the polyamine or copolymer thereof to form a hydrogel, wherein one or more amine groups of the polyamine or copolymer thereof is functionalised by the epoxide to form the optionally substituted alkanol group; and
grinding/crushing the hydrogel to form the hydrogel particulate.

51. The process of claim 50, wherein the functionalising epoxide is mixed with the solution comprising the polyamine or copolymer thereof to form the optionally substituted alkanol group prior to addition of the cross-linking agent, or the functionalising epoxide is mixed with the cross-linking agent prior to addition of the solution comprising the polyamine or copolymer thereof.

52. (canceled)

53. (canceled)

54. (canceled)

55. (canceled)

56. (canceled)

57. (canceled)

58. A method for removing an acidic gas from a gaseous stream or atmosphere, comprising contacting the gaseous stream or atmosphere with a hydrogel particulate of claim 1 to absorb at least some of the acidic gas from the gaseous stream or atmosphere into the hydrogel particulate.

59. The method of claim 58, wherein the acidic gas is carbon dioxide (CO₂) or hydrogen sulphide (H₂S), or a mixture thereof.

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. The method of claim 58, wherein the method further comprises a regeneration recovery method to desorb the absorbed acidic gas from the hydrogel.

73. (canceled)

74. (canceled)

75. (canceled)

76. (canceled)

77. An absorption apparatus comprising a chamber enclosing a hydrogel particulate for capturing an acidic gas from a gaseous stream or atmosphere of claim 1, wherein the chamber brings the gaseous stream or atmosphere into contact with the hydrogel particulate to absorb at least some of the acidic gas into the hydrogel particulate.

78. The adsorption apparatus of claim 77, wherein the chamber comprises an inlet through which gaseous stream or atmosphere can flow to the hydrogel particulate and an outlet through which an effluent gaseous stream can flow out from the hydrogel particulate.

79. The hydrogel particulate of claim 10, wherein the liquid swelling agent comprises one or more functional groups capable of binding to the acidic gas by a chemical process or is a liquid capable of absorbing acidic gas by a physical process.
